(19) United States
(12) Patent Application Publication
(10) Pub. No.: US 2022/0030115 A1
(43) Pub. Date: Jan. 27, 2022

(54) AUDIO CODING RE-SYNCHRONIZATION WITH RADIO ACCESS TRANSMISSION / RECEPTION TIMELINE FOR CDRX ENABLED VOIP SERVICE

(71) Applicant: QUALCOMM Incorporated, San Diego, CA (US)

(72) Inventors: Min WANG, San Diego, CA (US); Sudhir KRISHNAN, San Diego, CA (US); Manjunatha KANTHARAJU, Bangalore (IN); Shankar Ganesh LAKSHMANASWAMY, Bangalore (IN)

(21) Appl. No.: 16/936,764

(22) Filed: Jul. 23, 2020

(51) Int. Cl. H04M 7/00; H04L 29/06; H04W 36/30; H04W 36/00

(52) U.S. Cl. CPC H04M 7/0072; H04M 7/0084; H04L 65/80; H04L 1/1812; H04W 36/0069; H04W 36/0022; H04W 36/30

(57) ABSTRACT

Various embodiments include methods for determining when to resynchronize voice-over IP (VoIP) communications of the wireless device. Various embodiments may include storing one or more first call characteristics of the VoIP communications between the wireless device and a first base station, detecting whether the VoIP communications are transferred from the first base station to a second base station, analyzing one or more second call characteristics of the VoIP communications between the wireless device and the second base station, determining whether the one or more second call characteristics differ from the one or more first call characteristics, determining, within a total wait time, whether no active voice frames will be transmitted across an uplink, or no active voice frames will be provided to audio decoding, resynchronizing the VoIP communications in response to determining that the one or more second call characteristics differ from the one or more first call characteristics.

### BACKGROUND

Various radio access technologies (RATs) may utilize Voice over Internet Protocol (VoIP) to communicate audio signals from one wireless device to another wireless device. The audio signals can be encoded as speech frames that may be transmitted and received according to encoding and decoding timelines having transmit and receive reference times respectively. The transmit and receive reference times may be based on configuration settings of a base station. A handover event may occur when VoIP communications of a wireless device switch from being handled by one base station to another base station. The handover event may cause a change in the transmit and/or receive reference times. A change in the transmit and receive reference times implies that the audio function voice coding timelines matching with the previous transmit and receive reference times become unsynchronized with respect to the newly connected base station. Unsynchronized voice coding timelines may cause power consumption of a wireless device to increase and may decrease user experience by increasing mouth-to-ear delay. For example, attempting to immediately resynchronize an audio encoding and/or decoding timeline with the changed transmit and/or receive reference times without taking into account the ongoing call session characteristics may cause audio interruption in the transmit and/or receive directions.

### SUMMARY

Various aspects include methods performed by a processor of a wireless device for determining when to resynchronize voice-over IP (VoIP) communications of a wireless device during a voice call session.

Various aspects may include storing one or more first call characteristics of VoIP communications between a wireless device and a first base station, detecting whether the VoIP communications are transferred from the first base station to a second base station, and analyzing one or more second call characteristics of the VoIP communications between the wireless device and the second base station in response to detecting the VoIP communications are transferred from the first base station to the second base station, determining whether the one or more second call characteristics differ from the one or more first call characteristics, determining, within a total wait time, whether no active voice frames will be transmitted across an uplink to the second base station, or no active voice frames will be provided to audio decoding of the wireless device received across a downlink, and resynchronizing the VoIP communications in response to determining that the one or more second call characteristics differ from the one or more first call characteristics and in response to determining that no active voice frames will be transmitted across the uplink or no active voice frames will be provided to audio decoding received across the downlink during the total wait time.

Some aspects may further include resynchronizing the VoIP communications by resynchronizing an encoding timeline of the VoIP communications in response to determining, within the total wait time, that no active voice frames will be transmitted across the uplink to the second base station.

Some aspects may further include resynchronizing the VoIP communications by resynchronizing a decoding timeline of the VoIP communications in response to determining, within the total wait time, that no active voice frames will be provided to the audio decoding of the wireless device received across the downlink.

Some aspects may include analyzing the one or more second call characteristics of the VoIP communications between the wireless device and the second base station by analyzing a scheduling request (SR) configuration, which may include an SR periodicity and/or an SR offset, of the second base station, analyzing a connected mode discontinuous reception (CDRX) configuration, which may include one or more of CDRX cycle length, CDRX start time (offset), onDurationTimer value, downlink (DL) hybrid Automatic Repeat Request (HARQ) round trip time (DL HARQ-RTT) timer value, or a DL retransmission timer value, of the second base station, determining an encoding reference time of the VoIP communications between the wireless device and the second base station based on the SR configuration and the CDRX configuration, determining a decoding reference time of the VoIP communications between the wireless device and the second base station based on the CDRX configuration, and determining an audio exchange interval of the VoIP communications between the wireless device and the second base station based on the CDRX configuration.

Some aspects may further include determining whether the one or more second call characteristics differ from the one or more first call characteristics by determining one or more of whether: an encoding reference time of the VoIP communications between the wireless device and the first base station differs from an encoding reference time of the VoIP communications between the wireless device and the second base station, a decoding reference time of the VoIP communications between the wireless device and the first base station differs from a decoding reference time of the VoIP communications between the wireless device and the second base station, or an audio exchange interval of the VoIP communications between the wireless device and the first base station differs from an audio exchange interval of the VoIP communications between the wireless device and the second base station.

Some aspects may further include detecting whether the one or more first call characteristics are updated to become one or more updated call characteristics, determining whether the one or more updated call characteristics differ from the one or more first call characteristics in response to detecting that the one or more first call characteristics are updated to become the one or more updated call characteristics, determining, within the total wait time, whether no active voice frames will be transmitted across an uplink or no active voice frames will be provided to audio decoding of the wireless device received across a downlink, and resynchronizing the VoIP communications in response to determining that the one or more updated call characteristics differ from the one or more first call characteristics and in response to determining that no active voice frames will be transmitted across the uplink or no active voice frames will be provided to audio decoding received across the downlink during the total wait time.

Some aspects may further include detecting whether the VoIP communications are transferred from the second base station to a third base station before the VoIP communications are resynchronized to the second base station, analyzing one or more third call characteristics of the VoIP communications between the wireless device and the third base station in response to detecting that the VoIP communications are transferred from the second base station to the third base station, determining whether the one or more third call characteristics differ from the one or more first call characteristics, determining, within the total wait time, whether no active voice frames will be transmitted across an uplink to the third base station or no active voice frames will be provided to audio decoding of the wireless device received across a downlink, and resynchronizing the VoIP communications in response to determining that the one or more third call characteristics differ from the one or more first call characteristics and in response to determining that no active voice frames will be transmitted across the uplink or no active voice frames will be provided to audio decoding received across the downlink during the total wait time.

Some aspects may further include setting a resync timer to a minimum wait time in response to determining that the one or more second call characteristics differ from the one or more first call characteristics, starting the resync timer, in which resynchronizing the VoIP communications occurs before expiration of the resync timer and a hard resync timer. In some aspects, the total wait time may be a duration from a start time of the resync timer to the expiration of both the resync timer and the hard resync timer.

Some aspects may further include determining whether the resync timer and the hard resync timer have expired, and resynchronizing the VoIP communications in response to expiration of the resync timer and the hard resync timer.

In some aspects, the VoIP communications may be CDRX-enabled.

Further aspects may include a wireless device having a processor configured to perform one or more operations of the methods summarized above. Further aspects may include a non-transitory processor-readable storage medium having stored thereon processor-executable instructions configured to cause a processor of a wireless device to perform operations of the methods summarized above. Further aspects include a wireless device having means for performing functions of the methods summarized above. Further aspects include a system on chip for use in a wireless device that includes a processor configured to perform one or more operations of the methods summarized above. Further aspects include a system in a package that includes two systems on chip for use in a wireless device that includes a processor configured to perform one or more operations of the methods summarized above

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a system block diagram illustrating an example communications system 100 according to various embodiments.

FIG. 2 is a component block diagram illustrating an example computing system 200 suitable of implementing various embodiments.

FIG. 3 is a component block diagram of an example of a software architecture 300 including a radio protocol stack for the user and control planes in wireless communications suitable of implementing various embodiments.

FIG. 4 is a component block diagram illustrating an example system configured for determining when to resynchronize VoIP communications of a wireless device according to various embodiments.

FIG. 5 is a functional block diagram illustrating an example system for encoding and decoding audio data on a wireless device according to various embodiments.

FIG. 6 is a functional block diagram illustrating an example system including audio and transport functions for implementing CDRX within a wireless device according to various embodiments.

FIG. 7 illustrates an example CDRX timeline of a wireless device according to various embodiments.

FIG. 8 illustrates an example CDRX timeline of a wireless device according to various embodiments.

FIG. 9 illustrates an example unsynchronized CDRX timeline of a wireless device experiencing a base station handover event according to various embodiments.

FIG. 10 is a process flow diagram illustrating a method for monitoring frame types for determining when to resynchronize a decoding timeline of VoIP communications according to some embodiments.

FIG. 11 is a process flow diagram illustrating a method for determining when to resynchronize a decoding timeline of VoIP communications according to some embodiments.

FIG. 12 is a process flow diagram illustrating a method for determining when to resynchronize an encoding timeline of VoIP communications according to some embodiments.

FIG. 13 is a process flow diagram illustrating a method implementing a processor of a wireless device for determining when to resynchronize VoIP communications of the wireless device according to some embodiments.

FIG. 14 is a process flow diagram illustrating alternative operations that may be performed by a processor of a wireless device as part of the method for determining when to resynchronize VoIP communications of the wireless device according to some embodiments.

FIG. 15 is a process flow diagram illustrating alternative operations that may be performed by a processor of a wireless device as part of the method for determining when to resynchronize VoIP communications of the wireless device according to some embodiments.

FIG. 16 is a process flow diagram illustrating alternative operations that may be performed by a processor of a wireless device as part of the method for determining when to resynchronize VoIP communications of the wireless device according to some embodiments.

FIG. 17 is a process flow diagram illustrating alternative operations that may be performed by a processor of a wireless device as part of the method for determining when to resynchronize VoIP communications of the wireless device according to some embodiments.

FIG. 18 is a process flow diagram illustrating alternative operations that may be performed by a processor of a wireless device as part of the method for determining when to resynchronize VoIP communications of the wireless device according to some embodiments.

FIG. 19 is a process flow diagram illustrating alternative operations that may be performed by a processor of a wireless device as part of the method for determining when to resynchronize VoIP communications of the wireless device according to some embodiments.

FIG. 20 is a process flow diagram illustrating alternative operations that may be performed by a processor of a wireless device as part of the method for determining when to resynchronize VoIP communications of the wireless device according to some embodiments.

FIG. 21 is a component block diagram of an example of a network computing device that may determine when to resynchronize VoIP communications according to some embodiments.

FIG. 22 is a component block diagram of an example wireless device in the form of a smartphone suitable for implementing some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes and are not intended to limit the scope of the various embodiments or the claims.

Various embodiments provide solutions for performing audio coding resynchronization with radio access of a transmission and/or reception timeline for CDRX-enabled VoIP services. Various embodiments may include determining when an audio function timeline of a wireless device should be resynchronized, in which the wireless device has ongoing VoIP communications with another wireless device or a fixed device connected by a wired connection to a network. Various embodiments may include determining an optimized time within an encoding or decoding timeline of the audio function of the wireless device to perform resynchronization by determining when, if any, speech frames are being transmitted or received by the wireless device. Some embodiments may include resynchronizing the voice decoding timeline when the user of the wireless device is talking and another user of a connected wireless device or fixed device is listening, or both users are listening. Some embodiments may include resynchronizing the voice encoding timeline when the user of the wireless device is listening or both users of connected wireless or fixed devices are listening.

The term “wireless device” is used herein to refer to any one or all of cellular telephones, smartphones, portable computing devices, personal or mobile multi-media players, autonomous vehicles, wireless communication elements within autonomous and semiautonomous vehicles, wireless devices affixed to or incorporated into various mobile platforms, multimedia Internet-enabled cellular telephones, and similar electronic devices that include a memory, wireless communication components and a programmable processor.

The term “system-on-a-chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system-in-a-package” (SIP) is used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

Throughout this document, the terms “audio,” “voice,” and “speech” may be used interchangeably. Throughout this document, the terms “decoding reference time” and “receive reference time” may be used interchangeably. Throughout this document, the terms “encoding reference time” and “transmit reference time” may be used interchangeably.

To achieve an optimal balance between mouth-to-ear delay and wireless device power consumption, mobile network operator (MNO) networks may enable CDRX for conversational IP multimedia subsystems (IMS) voice services such as VoLTE (Voice over LTE) and VoNR (Voice over NR). Wireless communication systems using various radio access technologies (RATs) may implement CDRX to enable wireless devices to conserve battery power. Voice codecs deployed for VoIP services typically encode every 20 ms audio input to a frame, i.e., audio frame length (frame length) is typically 20 ms. The CDRX cycle length for a VoIP call is thus usually configured by the wireless system as an integer multiple of audio frame length (e.g., CDRX cycle length may be configured to be 20 ms, 40 ms, etc.). CDRX may be activated on an IC of a wireless device to conserve power by powering down a significant portion of the circuitry of the IC when there are no incoming data packets to be processed or outgoing data packets to be transmitted. While in a CDRX mode, the IC may receive configuration information from the physical downlink control channel (PDCCH) to determine when data packets are incoming, and thus when the IC should reactivate powered-down portions in preparation for receiving the incoming data packets. Continuously power cycling portions of an IC may involve complex timing schemes to maximize power conservation while ensuring wireless communications services and user experiences are not degraded. Continuously correcting for jitter, such as eliminating jitter by repeatedly loading a reference clock from an external source among all devices intending to be synchronized may be time consuming and demanding on available computing resources.

For example, when CDRX is enabled, a wireless device should be “on” during a CDRX on duration to monitor, via the PDCCH, the base station for the uplink grant, if the wireless device has uplink data to transmit, and/or for receiving downlink data reception. After an uplink transmission and/or downlink reception is completed, various portions of the wireless device can turn off, or “fall asleep” until the next CDRX cycle starts. In some embodiments, retransmission may occur when a block error rate (BLER) is greater than zero, therefore causing the wireless device to stay on longer during a single CDRX cycle.

To maximize the sleep time as well as minimize the mouth-to-ear delay, the timelines of voice encoding and decoding may be aligned, or synchronized with the CDRX on duration. Synchronization of the encoding and decoding timelines may take into account uplink and downlink processing times of the wireless device, wireless device modem wake-up time (i.e. modem transition from power collapse/off to power active/on), and scheduling requests (SR) times for requesting uplink grants from a base station. An SR occasion to request an uplink grant may be selected to maximize the sleep time as well as minimize the mouth-to-ear delay according to SR configuration and CDRX configuration, referred as the selected SR occasion in the rest of the document.

A wireless device may be travelling while implementing VoIP communications for an active call with another wireless or fixed device. Thus, the wireless device may travel between various network coverage areas, such that the wireless device may experience one or more handover events from one base station to another base station during an active voice call. When a handover event occurs, one or more SR and/or CDRX configuration parameters, such as standardized parameters including SR periodicity and offset and CDRX cycle, CDRX start offset (which determines CDRX start time), CDRX on duration, etc., may be changed. SR configuration and/or CDRX configuration may be configured depending on the radio access technology (RAT) being implemented. For example, LTE-enabled base station may implement an sr-ConfigIndex parameter to configure SR periodicity and offset, in which sr-ConfigIndex is specified in LTE specification 3GPP TS 36.331. For example, sr-ConfigIndex=9 indicates the SR periodicity and SR offset are 10 ms and 4 ms, respectively. As another example, sr-ConfigIndex=14 indicates the SR periodicity and SR offset are 10 ms and 9 ms, respectively. Other sr-ConfigIndex parameter values indicating various SR periodicity and SR offset values may be defined according to industry standard 3GPP TS 36.213 Table 10.1.5-1: “UE-specific SR periodicity and subframe offset configuration.”

As another example for configuring SR periodicity and SR offset, a New Radio (NR)-enabled base station may implement a periodicityAndOffset parameter in SchedulingRequestResourceConfig IE to configure SR periodicity and offset, in which periodicityAndOffset in SchedulingRequestResourceConfig is specified in NR specification 3GPP TS 38.331. In NR industry standards, the periodicityAndOffset is given as slx:y, meaning that the SR periodicity is x slots and the SR offset is y slots. The length of a slot is subcarrier-spacing (SCS) dependent.

For example, If the SCS is 15 kHz, one slot is 1 ms, and if the SCS is 30 kHz, one slot is 0.5 ms. In LTE, the SCS is always 15 kHz. In NR, the SCS may be configured as 15 kHz, 30 kHz, 60 kHz, and 120 kHz. For example, if the SCS is 15 kHz, periodicityAndOffset=sl10:4 indicates the SR periodicity and SR offset are 10 ms and 4 ms, respectively. In LTE, there is only one SR configuration. In NR, the standard allows a specific SR configuration per logical channel. For reference throughout this document, when SR configuration is discussed in the context of NR, the SR configuration is with respect to the voice logical channel.

CDRX configuration parameters may include LTE CDRX configuration parameters specified in 3GPP TS 36.331 and TS 36.321, such as longDRX-CycleStartOffset (defines long CDRX cycle length and CDRX start offset), shortDRX (shortDRX-Cycle, drxShortCycleTimer), onDurationTimer, drx-InactivityTimer, and drx-RetransmissionTimer. In some embodiments, LTE configuration parameters longDRX-CycleStartOffset and shortDRX may be used in addition to LTE SR configuration parameters to determine transmit reference times. In some embodiments, LTE configuration parameters longDRX-CycleStartOffset, shortDRX, and onDurationTimer may be used to determine receive reference times. In some embodiments, LTE configuration parameter drx-RetransmissionTimer may be used to determine receive references times.

CDRX configuration parameters may further include NR CDRX configuration parameters specified in 3GPP TS 38.331 and TS 38.321, such as drx-LongCycleStartOffset (defines long CDRX cycle length and CDRX start offset), shortDRX (drx-ShortCycle, drx-ShortCycleTimer), drx-slotOffset, drx-onDurationTimer, drx-InactitityTimer, drx-HARQ-RTT-TimerDL, drx-HARQ-RTT-TimerUL, drx-RetransmissionTimerDL, and drx-RetransmissionTimerUL. In some embodiments, NR configuration parameters drx-LongCycleStartOffset, shortDRX, and drx-slotOffset may be used in addition to NR SR configuration parameters to determine transmit reference times. In some embodiments, NR configuration parameters drx-LongCycleStartOffset, shortDRX, drx-slotOffset, and drx-onDurationTimer may be used to determine receive reference times. In some embodiments, NR configuration parameters drx-HARQ-RTT-TimerDL and drx-RetransmissionTimerDL may be used to determine receive references times. In both LTE and NR implementations, the CDRX cycle length may be used to define the audio exchange interval between audio function and transport function: if shortDRX is configured, the CDRX cycle length is the short DRX cycle; and if the shortDRX is not configured, then the CDRX cycle length is equal to the long CDRX cycle length.

Changes in the SR and/or CDRX configuration parameters as configured by the newly connected base station may result in new transmit reference times (e.g., Tx_Ref_Time), receive reference times (e.g., Rx_Ref_Time), and/or audio exchange interval (e.g., Audio_Exchange_Interval). The voice encoding and decoding timeline of the CDRX-enabled wireless device matching with the previous transmit, receive reference times, and/or audio exchange interval becomes unsynchronized with respect to the newly connected base station. Unsynchronized voice coding timelines may cause power consumption of a wireless device to increase and may decrease user experience by increasing mouth-to-ear delay.

Various embodiments provide for audio function voice encoding and decoding resynchronization to achieve maximum CDRX power conservation and minimum mouth-to-ear delay of audio signals for a user's experience. Various embodiments provide for audio coding timeline resynchronization to achieve minimum impact to voice quality by determining an optimized time to perform resynchronization.

In some embodiments, encoding and decoding timelines may be resynchronized based on the speech frames, or lack thereof, being transmitted or received by a wireless device between a base station. Voice encoding and voice decoding operations of a wireless device may be decoupled so that the voice encoding timeline and the voice decoding timeline may be resynchronized and/or reconfigured independently from each other.

In some embodiments, call characteristics (e.g., SR configuration, CDRX configuration, the selected SR occasion to request voice uplink grant, the offset of the selected SR occasion with respect to the CDRX start time (SR_OFF), voice encoding/transmit reference times, voice decoding/receive reference times, audio exchange interval, etc.) may be used to determine if and when resynchronization of an audio coding timeline should be performed to maximize power conservation and minimize audio delay. Resynchronization may cause multiple voice frames to be interrupted (e.g., three voice frames) on the uplink if the user is talking and/or the downlink if the user is listening and the remote user is talking, which causes audible voice quality degradation to the remote user if interruption occurs on uplink while the local user is talking or to the local user if interruption occurs on downlink while the remote user is talking. For this reason, determining an optimal time to perform an encoding or decoding resynchronization may reduce or eliminate audio quality degradation. In some embodiments, to eliminate potential audible voice quality degradation on either or both sides, a wireless device may utilize characteristics of a typical VoLTE/VoNR call to determine an optimal time within a certain time to actually perform audio coding timeline resynchronization. For example, a wireless device may monitor or otherwise determine when one user of the wireless device is talking and another user of another wireless device on the call is listening, and vice versa, with the additional possibility of monitoring for intervals when both users are listening and not talking. In some embodiments, a wireless device may determine that DTX (Discontinuous Transmission) has been enabled in a VoLTE/VoNR call. DTX is an operating mode of voice codec that is used in conventional VoIP services. In a VoIP call, usually one side is talking while the other side is listening and vice versa or both sides are listening. In non-DTX mode (i.e., DTX is disabled), the voice encoder encodes all input as “speech frame,” regardless of whether the user of a wireless device is talking or listening. Thus, all “speech frame” are transmitted to the remote side. In DRX mode (i.e., DTX is enabled), the voice encoder encodes speech signal (i.e., when the user is talking) as “speech frame,” and background noise (i.e., when the user is listening) as either NO_DATA frame or silence descriptor (SID) frame. NO_DATA frames are not transmitted to the remote side. Only “speech frames” and SID frames are transmitted to the remote side. Therefore, when DTX is enabled, the device may use the frame types to determine the voice activity states of the local user and the remote user, the voice decoding timeline may be resynchronized if the user is talking and the other side is listening or both sides are listening, and the voice encoding timeline may be resynchronized if the user is listening or both sides are listening. Thus, audio encoding and decoding timelines may be resynchronized without audio data loss while optimizing the durations of CDRX device low-power and normal-power states to achieve maximum power conservation and minimum audio mouth-to-ear delay.

In some embodiments, if the wireless device is unable to determine whether a user is talking, listening, and/or both users are listening based on monitoring the uplink and downlink for audio data frames, resynchronization of the encoding and/or decoding timelines may be performed regardless. For example, if the wireless device is unable to determine an ideal time to perform resynchronization (e.g., both users are continuously talking, too much background noise to distinguish speech from background noise, DTX is disabled, etc.), resynchronization may be performed regardless of user voice activity after a configurable time. For example, the wireless device may determine that resynchronization should be performed after a handover event, may determine that resynchronization may not be presently ideal to perform such that it may interrupt or increase audio mouth-to-ear delay, but may perform resynchronization of the encoding and/or decoding timelines regardless after a predefined time.

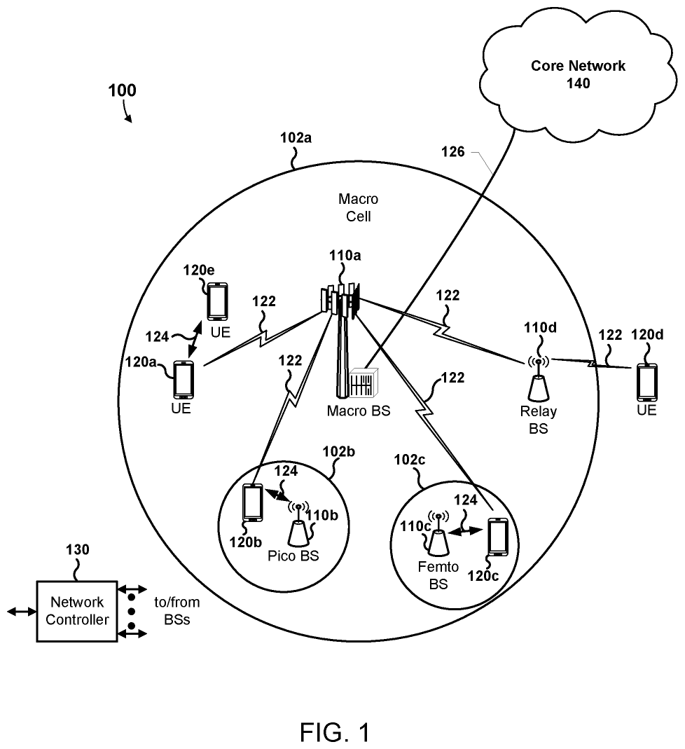

FIG. 1 is a system block diagram illustrating an example communications system 100 suitable for implementing various embodiments. The communications system 100 may be an 5G NR network, or any other suitable network such as (but not limited to) an LTE network.

The communications system 100 may include a heterogeneous network architecture that includes a core network 140 and a variety of wireless devices (illustrated as wireless device 120a-120e in FIG. 1). The communications system 100 also may include a number of base stations (illustrated as the BS 110a, the BS 110b, the BS 110c, and the BS 110d) and other network entities. A base station is an entity that communicates with wireless devices, and also may be referred to as an NodeB, a Node B, an LTE evolved nodeB (eNB), an access point (AP), a radio head, a transmit receive point (TRP), a New Radio base station (NR BS), a 5G NodeB (NB), a Next Generation NodeB (gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by wireless devices with service subscription. A pico cell may cover a relatively small geographic area and may allow unrestricted access by wireless devices with service subscription. A femto cell may cover a relatively small geographic area (for example, a home) and may allow restricted access by wireless devices having association with the femto cell (for example, wireless devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1, the base station 110a may be a macro BS for a macro cell 102a, the base station 110b may be a pico BS for a pico cell 102b, and the base station 110c may be a femto BS for a femto cell 102c. One or more of the base stations 110a-110d may support one or multiple (for example, three) cells. The terms “eNB,” “base station,” “NR BS,” “gNB,” “TRP,” “AP,” “node B,” “5G NB,” and “cell” may be used interchangeably herein.

A cell may not be stationary, and the geographic area of the cell may move according to the location of a mobile base station. The base stations 110a-110d may be interconnected to one another as well as to one or more other base stations or network nodes (not illustrated) in the communications system 100 through various types of backhaul interfaces, such as a direct physical connection, a virtual network, or a combination thereof using any suitable transport network

The base station 110a-110d may communicate with the core network 140 over a wired or wireless communication link 126. The wireless device 120a-120e may communicate with the base station 110a-110d over a wireless communication link 122.

The wired communication link 126 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay BS 110d). A relay station is an entity that can receive a transmission of data from an upstream station (for example, a base station or a wireless device) and send a transmission of the data to a downstream station (for example, a wireless device or a base station). A relay station also may be a wireless device that can relay transmissions for other wireless devices. In the example illustrated in FIG. 1, the relay base station 110d may communicate with the macro base station 110a and the wireless device 120d in order to facilitate communication between the base station 110a and the wireless device 120d. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations (e.g., one or more of the base stations 110a-10d) and may provide coordination and control for these base stations. The network controller 130 may communicate with the base stations via a backhaul (not shown). The base stations 110a-110d also may communicate with one another, for example, directly or indirectly via a wireless or wireline backhaul.

The wireless devices 120a, 120b, 120c may be dispersed throughout communications system 100, and each wireless device may be stationary or mobile. A wireless device also may be referred to as an access terminal, a terminal, a mobile station, a subscriber unit, a station, etc.

The macro base station 110a may communicate with the communication network 140 over a wired or wireless communication link 126. The wireless devices 120a, 120b, 120c may communicate with one or more of the base stations 110a-110d over a wireless communication link 122.

The wireless communication links 122, 124 may include a plurality of carrier signals, frequencies, or frequency bands, each of which may include a plurality of logical channels. The wireless communication links 122 and 124 may utilize one or more RATs. Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links 122, 124 within the communications system 100 include medium range protocols such as Wi-Fi, LTE-U, LTE-Direct, LAA, MuLTEfire, and relatively short-range RATs such as ZigBee, Bluetooth, and Bluetooth Low Energy (LE).

Certain wireless networks (such as LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e. 6 resource blocks), and there may be 1, 2, 4, 8 or 16 subbands for system bandwidth of 1.25, 2.5, 5, 10 or 20 MHz, respectively.

While descriptions of some implementations may use terminology and examples associated with LTE technologies, some implementations may be applicable to other wireless communications systems, such as a New Radio (NR) or 5G network. NR may utilize OFDM with a cyclic prefix (CP) on the uplink (UL) and downlink (DL) and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e. DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per wireless device. Multi-layer transmissions with up to 2 streams per wireless device may be supported. Aggregation of multiple cells may be supported with up to eight serving cells. Alternatively, NR may support a different air interface, other than an OFDM-based air interface.

In general, any number of communications systems and any number of wireless networks may be deployed in a given geographic area. Each communications system and wireless network may support a particular RAT and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, NR or 5G RAT networks may be deployed.

In some implementations, two or more wireless devices 120a-e (for example, illustrated as the wireless device 120a and the wireless device 120e) may communicate directly using one or more sidelink channels 124 (for example, without using a base station 110a-110d as an intermediary to communicate with one another).

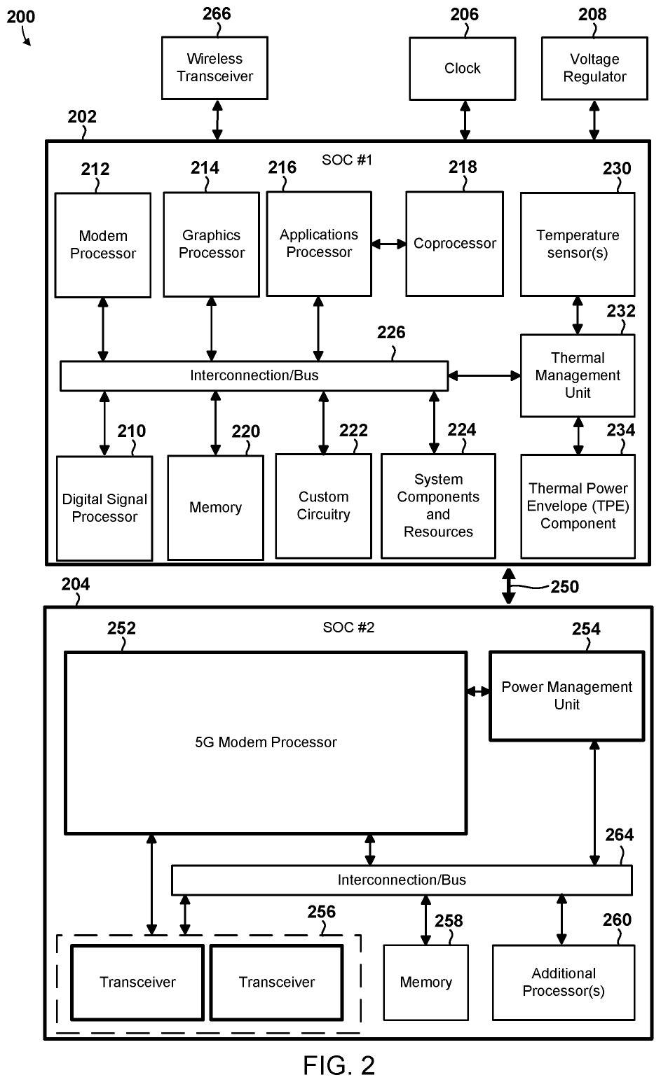

FIG. 2 is a component block diagram illustrating an example computing system that may be configured to preload wireless data within a wireless communication network based on predicted network status and predicted user behavior according to some embodiments. Various implementations may be implemented on a number of single processor and multiprocessor computer systems, including a SOC or a SIP. The example illustrated in FIG. 2 is a SIP 200 architecture that may be used in wireless devices and network devices implementing the various implementations.

With reference to FIGS. 1 and 2, the illustrated example SIP 200 includes two SOCs 202, 204, a clock 206, a voltage regulator 208 and a wireless transceiver 266. In some implementations, the first SOC 202 may operate as central processing unit (CPU) of the wireless device that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), or very high frequency short wave length (such as 28 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuity 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of transceivers 256 (e.g., such as sub-6 band transceivers, mmWave transceivers or other wireless transceivers), memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.). In some implementations, any or all of the processors 210, 212, 214, 216, 218, 252, 260 may be a component of a processing system. A processing system may generally refer to a system or series of machines or components that receives inputs and processes the inputs to produce a set of outputs (which may be passed to other systems or components of, for example, the first SOC 202 or the second SOC 250). For example, a processing system of the first SOC 202 or the second SOC 250 may refer to a system including the various other components or subcomponents of the first SOC 202 or the second SOC 250.

The processing system of the first SOC 202 or the second SOC 250 may interface with other components of the first SOC 202 or the second SOC 250. The processing system of the first SOC 202 or the second SOC 250 may process information received from other components (such as inputs or signals), output information to other components, etc. For example, a chip or modem of the first SOC 202 or the second SOC 250 may include a processing system, a first interface to output information, and a second interface to receive information. In some cases, the first interface may refer to an interface between the processing system of the chip or modem and a transmitter, such that the first SOC 202 or the second SOC 250 may transmit information output from the chip or modem. In some cases, the second interface may refer to an interface between the processing system of the chip or modem and a receiver, such that the first SOC 202 or the second SOC 250 may receive information or signal inputs, and the information may be passed to the processing system. A person having ordinary skill in the art will readily recognize that the first interface also may receive information or signal inputs, and the second interface also may transmit information.

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the transceivers 256, memory 258, and various additional processors 260 via the interconnection/bus module 264. The interconnection/bus module 226, 250, 264 may include an array of reconfigurable logic gates or implement a bus architecture (such as CoreConnect, AMBA, etc.). Communications may be provided by advanced interconnects, such as high-performance networks-on chip (NoCs).

The first or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, various implementations may be implemented in a wide variety of computing systems, which may include a single processor, multiple processors, multicore processors, or any combination thereof.

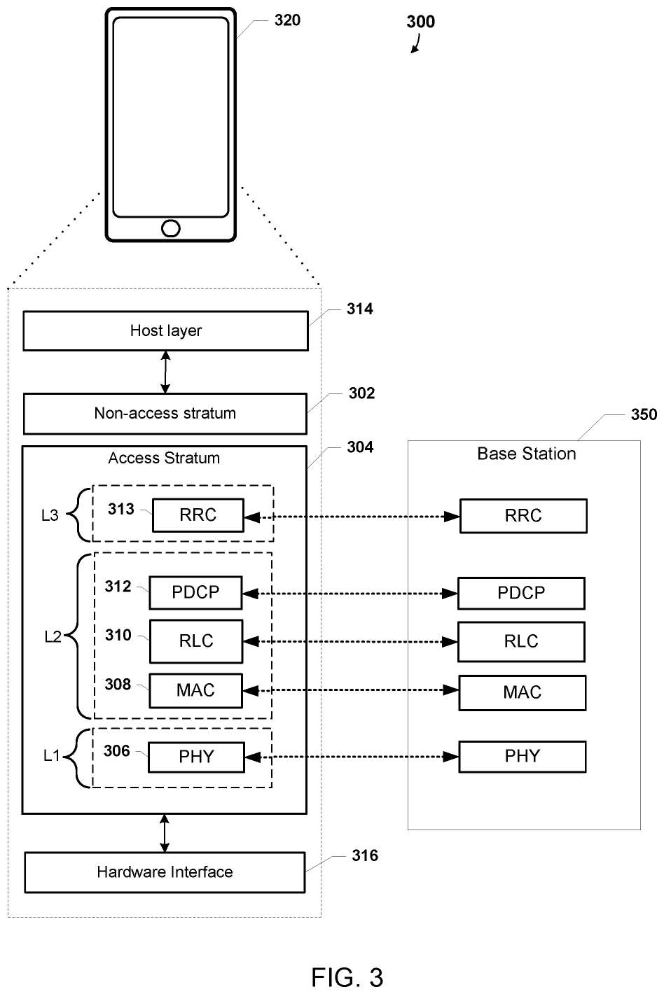

FIG. 3 is a component block diagram of an example of a software architecture 300 including a radio protocol stack for the user and control planes in wireless communications that may be implemented in various embodiments. The software architecture 300 including a radio protocol stack for the user and control planes in wireless communications between a base station 350 (such as the base station 110a in FIG. 1) and a wireless device 320 (such as the wireless device 120a-120e, 200 in FIGS. 1-2). With reference to FIGS. 1-3, the wireless device 320 may implement the software architecture 300 to communicate with the base station 350 of a communication system (such as the communications system 100). In various implementations, layers in software architecture 300 may form logical connections with corresponding layers in software of the base station 350. The software architecture 300 may be distributed among one or more processors (such as the processors 212, 214, 216, 218, 252, 260). While illustrated with respect to one radio protocol stack, in a multi-SIM (subscriber identity module) wireless device, the software architecture 300 may include multiple protocol stacks, each of which may be associated with a different SIM (such as two protocol stacks associated with two SIMs, respectively, in a dual-SIM wireless communication device). While described below with reference to LTE communication layers, the software architecture 300 may support any of variety of standards and protocols for wireless communications, or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the wireless device (such as SIM(s) 204) and its core network 140. The AS 304 may include functions and protocols that support communication between a SIM(s) (such as SIM(s) 204) and entities of supported access networks (such as a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission or reception over the air interface. Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the wireless device 320 and the base station 350 over the physical layer 306. In the various implementations, Layer 2 may include a media access control (MAC) sublayer 308, a radio link control (RLC) sublayer 310, and a packet data convergence protocol (PDCP) 312 sublayer, each of which foul logical connections terminating at the base station 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In various implementations, the RRC sublayer 313 may provide functions including broadcasting system information, paging, and establishing and releasing an RRC signaling connection between the wireless device 320 and the base station 350.

In various implementations, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In some embodiments implementing LTE communications, both segmentation and concatenation may be performed in the RLC sublayer 310. In some embodiments implementing NR communications, segmentation may be performed in the RLC sublayer 310, and concatenation may be performed in the MAC 308. In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid Automatic Repeat Request (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the wireless device 320. In some implementations, application-specific functions provided by the at least one host layer 314 may provide an interface between the software architecture and a processor.

In other implementations, the software architecture 300 may include one or more higher logical layer (such as transport, session, presentation, application, etc.) that provide host layer functions. For example, in some implementations, the software architecture 300 may include a network layer (such as Internet Protocol (IP) layer) in which a logical connection terminates at a packet data network (PDN) gateway (PGW). In some implementations, the software architecture 300 may include an application layer in which a logical connection terminates at another device (such as end wireless device, server, etc.). In some implementations, the software architecture 300 may further include in the AS 304 a hardware interface 316 between the physical layer 306 and the communication hardware (such as one or more radio frequency (RF) transceivers).

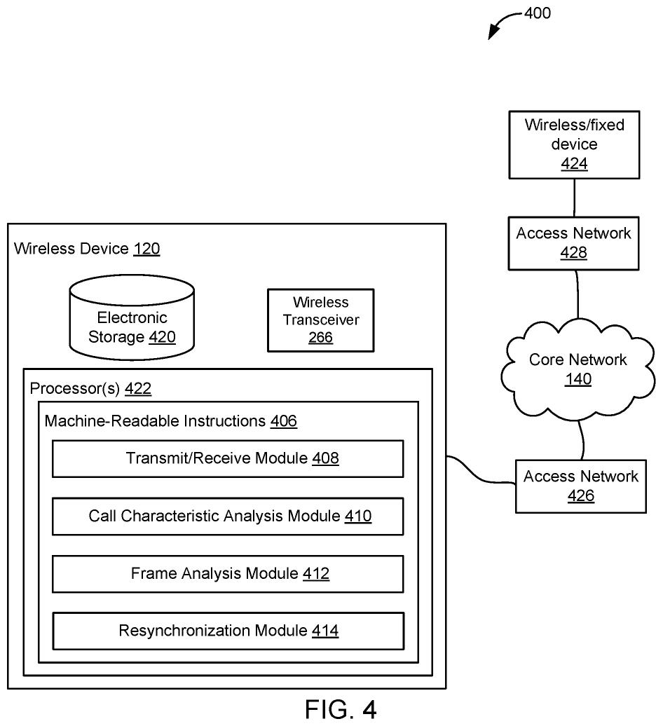

FIG. 4 is a component block diagram illustrating an example system 400 configured for determining when to resynchronize voice-over IP (VoIP) communications of a wireless device according to various embodiments. With reference to FIGS. 1-4, the system 400 may include one or more wireless device(s) 120 (e.g., the wireless device(s) 120a-120e) or one or more wireless/fixed devices 424, which may communicate via a core network 140 connected to access networks 426 and 428 (e.g., base station 110, additional eNB/gNB).

The wireless device(s) 120 may be configured by machine-readable instructions 406. Machine-readable instructions 406 may include one or more instruction modules. The instruction modules may include computer program modules. The instruction modules may include one or more of a transmit/receive module 408, a call characteristic analysis module 410, a frame analysis module 412, a resynchronization module 414, and other instruction modules (not illustrated). The wireless device 120 may include electronic storage 420 that may be configured to store information related to functions implemented by the transmit/receive module 408, the call characteristic analysis module 410, the frame analysis module 412, the resynchronization module 414, and any other instruction modules. The wireless device 120 may include processor(s) 422 configured to implement the machine-readable instructions 406 and corresponding modules.

The transmit/receive module 408 may be used to configure and/or transmit and receive data and control messages to and from a base station. In some embodiments, the transmit/receive module 408 may detect whether VoIP communications for an active call between devices are transferred from the one base station to another base station.

The call characteristic analysis module 410 may be used to analyze call characteristics of a VoIP call. In some embodiments, the call characteristic analysis module 410 may analyze one or more call characteristics of VoIP communications between the wireless device and a base station. In some embodiments, the call characteristic analysis module 410 may analyze one or more additional call characteristics of VoIP communications between the wireless device and another base station in response to detecting the VoIP communications are transferred from one base station to another base station.

The frame analysis module 412 may be used to determine a type of frame being transmitted or received during VoIP communications. For example, the frame analysis module 412 may analyze dequeued frames and/or frames contained within a de jitter buffer. Determining the types of frames may be performed to determine when to perform resynchronization during an active VoIP call. In some embodiments, the frame analysis module may determine whether no active voice frames are being transmitted across an uplink to a base station during a total wait time, or whether no active voice frames are being received across a downlink from a base station during the total wait time.

The resynchronization module 414 may perform resynchronization of encoding and/or decoding VoIP timelines. In some embodiments, the resynchronization module 414 may resynchronize VoIP communications in response to determining that one or more call characteristics for a previous wireless device-to-base station session differ from one or more call characteristics for a current wireless device-to-base station session, and in response to determining that no active voice frames are being transmitted or received across the uplink or the downlink during the total wait time.

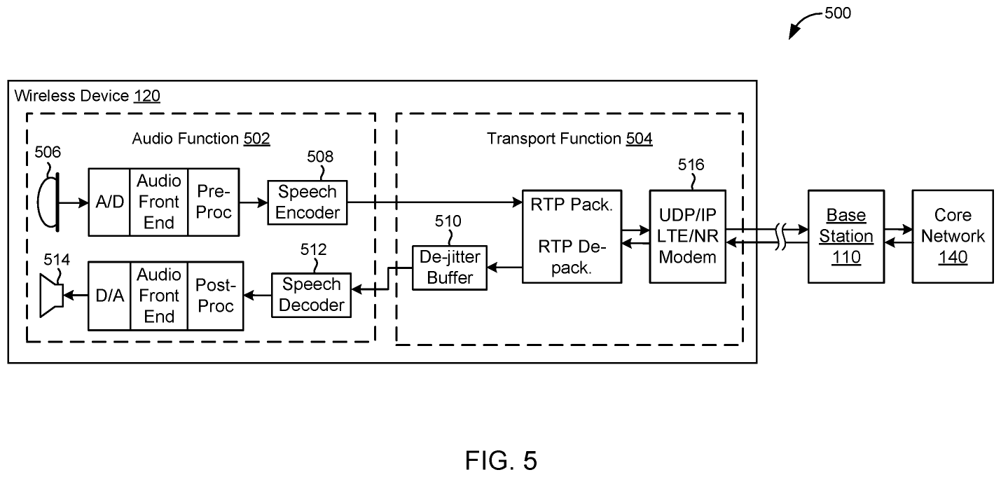

FIG. 5 is a functional block diagram illustrating an example system 500 for encoding and decoding audio data on a wireless device according to various embodiments. The wireless device 120 may include an audio function 502 and a transport function 504 to communicate audio data to and from the base station 110 and core network 140. For illustrative purposes, the audio function 502 is depicted as a functional block separate from the transport function 504, but components and/or functional blocks of either the audio function 502 and the transport function 504 may be depicted as being part of various functions blocks according to conventional examples of wireless devices implementing VoLTE/VoNR technology.

The audio function 502 may include an audio input component 506 (e.g., microphone), a speech encoder 508, a speech decoder 512, an audio output component 514 (e.g., speaker), and various audio processing components analog-to-digital (A/D) converter, audio front end (AFE), pre-processing, digital-to-analog (D/A) converter, and post-processing. The transport function may include a de-jitter buffer 510, a real-time transport protocol (RTP) packetization/depacketization functional block, and a user datagram protocol/IP LTE/NR modem 516.

The transport function 504 may be configured by the base station 110 to cause the wireless device 120 to implement CDRX. The base station 110 may transmit an RRC message to the UDP/IP LTE/NR modem 516 for CDRX configuration and SR configuration. The RRC message may include information to configure CDRX and SR such as one or more of CDRX cycle length, CDRX cycle start time, CDRX on duration time (e.g., onDurationTimer), DL HARQ round trip time (HARQ-RTT) timer value, DL Retransmission timer value, SR periodicity and offset, etc. In response to the transport function 504 receiving the RRC message from the base station 110, the wireless device 120 may cause the transport function 504 to provide control signaling to the audio function 502. The control signaling includes information, such as transmit reference time, receive reference time, and audio exchange interval (e.g., Tx_Ref_Time, Rx_Ref_Time, Audio_Exchange_Interval) that may configure the audio coding timeline (i.e. audio encoding timeline and audio decoding timeline). The transmit reference time may configure the time that the audio function 502 will have the encoded voice frame(s) available for transmission. The transmit reference time may be equal to a total time to perform the selected SR occasion offset with respect to the CDRX start time, a wakeup time of the UDP/IP LTE/NR modem 516, and an uplink processing time of the UDP/IP LTE/NR modem 516. In some embodiments, the transmit reference time may not include and may be independent of a modem wakeup time. The receive reference time may configure the time for the de jitter buffer 510 to provide the voice frame(s) for decoding. The receive reference time may be equal to a total time to perform the CDRX on duration time and a downlink processing time of the UDP/IP LTE/NR modem 516.

The Audio Exchange Interval may refer to the interval of time to perform audio frame exchanges between the audio function 502 and the transport function 504. The audio function 502 may utilize the Audio_Exchange_Interval to determine the length of the speech signal to be encoded and provided to transport function by Tx_Ref_Time and the length of the speech signal to start decode at Rx_Ref_Time. Audio_Exchange_Interval must be an integer multiple of audio speech frame length (e.g., frame_length) which is typically 20 ms for audio codecs for VoIP services. Audio_Exchange_Interval is typically set to CDRX cycle length configured by the eNB/gNB. However, in some embodiments, Audio_Exchange_Interval may be smaller or larger than the CDRX cycle length conventionally configured by eNB/gNB in some special use cases. For example, if eNB/gNB configures the CDRX cycle length to be 40 ms, Audio_Exchange_Interval can be configured to 20 ms instead of 40 ms by the transport function 504. As another example, if eNB/gNB configures the CDRX cycle length to be 10 ms, Audio_Exchange_Interval can be configured to 20 ms by the transport function 504. Whether Audio_Exchange_Interval alone impacts audio coding timeline depends on whether audio coding operates according to Audio_Exchange_Interval or not. If audio codec coding operates according to Audio_Exchange_Interval, audio codec may encode/decode Audio_Exchange_Interval/frame_length_audio frames a time. For example, if frame_length=20 ms and Audio_Exchange_Interval=40 ms, then the audio codec encodes/decodes two audio frames back to back a time. However, if audio codec coding always encodes/decodes one frame a time regardless of the Audio_Exchange_Inteval, then the change of Audio_Exchange_Interval alone does not impact audio coding timeline, which is equivalent to configuring Audio_Exchange_Interval to frame_length. Thus, with Tx_Ref_Time, Rx_Ref_Time, and Audio_Exchange_Interval, the audio function 502 may precisely determine its audio encoding timeline and decoding timeline.

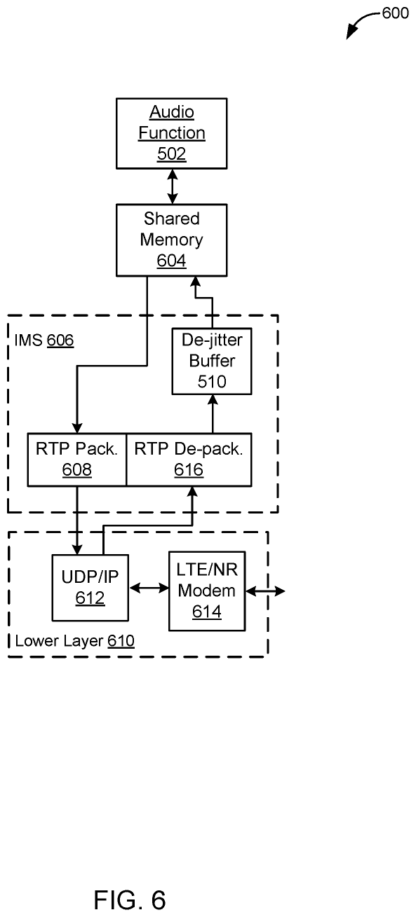

FIG. 6 is a functional block diagram illustrating an example system 600 including audio and transport functions for implementing CDRX within a wireless device according to various embodiments. The system 600, which represents various functional blocks within a wireless device may include the audio function 502, a shared memory 604, an IP multimedia subsystem (IMS) 606, and a lower layer 610. The IMS 606 may include RTP packetization 608 for uplink packets, RTP depacketization 616 for downlink packets, and de jitter buffer 510. The lower layer 610, which may be part of a transport function (e.g., transport function 504 as described with reference to FIG. 5), may include UDP/IP functional block 612 and LTE/NR modem 614. The shared memory 604 may be located or communicatively coupled between the audio function and the transport function to exchange voice frames.

At a VoIP call setup, during a VoIP call, or during a VoIP call that experiences a handover event between base stations (i.e. SR configuration and CDRX configuration change), the LTE/NR modem 614 may provide configuration information to the IMS 606. The configuration information may include a CDRX cycle length, a CDRX start time (e.g., CDRX_start, which is the CDRX cycle start time in modem system time, reflecting the eNB/gNB configured CDRX offset), an uplink packets offset time (e.g., UPO_CCST, which is the uplink packets offset time with respect to CDRX cycle start time), an on-duration time (e.g., ODT, which is the eNB/gNB configured CDRX onDurationTimer value), a lower layer downlink processing time (DL_P′, which is the processing time from PHY, through MAC, RLC, PDCP, and UDP/IP functional block 612 to the input of RTP depacketization 616), and a lower layer uplink processing time (UL_P′), which is the processing time from the output of RTP Packetization 608, through UDP/IP functional block 612, to PDCP (may include robust header compression (ROHC) processing, if ROHC is enabled). In some embodiments, the lower layer uplink processing time and lower layer downlink processing time may be provided to the IMS 606 via configuration rather than as application program interfaces (APIs), since these processing times are modem dependent only and thus not changed per call session.

In some embodiments, an SR occasion offset (e.g., SR_OFF) may represent the offset of the selected SR occasion with respect to the next CDRX start time, which may be positive if ahead of or before the CDRX start time, negative if behind or after the CDRX start time, and with value 0 if perfectly aligned with the CDRX start time). In some embodiments, a modem wakeup time (e.g., WUT) may represent the wakeup time of the LTE/NR modem 614 from power collapse to being fully powered on (i.e. modem hardware and RF “wake up” from a “sleep” state). In some embodiments in which the SR occasion offset is a positive value, the uplink packets offset time may be equal to the sum of the lower layer uplink processing time, the modem wakeup time (WUT), and the SR occasion offset (e.g., UPO_CCST=UL_P′+WUT+SR_OFF) if the actual arrival of the packet(s) from the audio function 502 is required to trigger the LTE/NR modem 614 to wake up. In some embodiments in which the SR occasion offset is a positive value, if the modem wakeup time is scheduled without requiring the arrival of the packet(s) from the audio function 502 (e.g., knowing an UL transmission beforehand, or configuring the modem wakeup time by default against the selected SR occasion or CDRX start time, whichever is sooner), the uplink packets offset time may be equal to the sum of the lower layer uplink processing time and the SR occasion offset (e.g., UPO_CCST=UL_P′+SR_OFF). In some embodiments in which the SR occasion offset is less than or equal to zero, the uplink packets offset time may be equal to the lower layer uplink processing time (e.g., UPO_CCST=UL_P′).

A total uplink processing time (e.g., UL_P) may refer to the processing time from input to the RTP packetization 608 through to the PDCP. More specifically, the total uplink processing time may include processing time of the packet from the audio function 502 to the RTP packetization 608, UDP/IP functional block 612, and PDCP if enabled including ROHC processing, to trigger the SR transmission. The total uplink processing time may be equal to the sum of RTP packetization time (e.g., UL_P″) and the lower layer uplink processing time (e.g., UL_P′) (i.e. UL_P=UL_P″+UL_P′). A total downlink processing time (e.g., DL_P) may refer to the processing time from the PHY through to the de-jitter buffer 510 output. More specifically, the total downlink processing time may include processing time from the PHY, MAC, RLC, and UDP/IP functional block 612, to the RTP depacketization 616 and through to operation of the de jitter buffer 510. The total downlink processing time may be equal to the sum of RTP depacketization time combined with the de jitter buffer 510 processing time (DL_P″) and the lower layer downlink processing time (e.g., DL_P′) (i.e. UL_P=DL_P″+DL_P′). Modem wakeup time from sleep, uplink processing time, and downlink processing time may be modem dependent depending on the wireless device implementation, and may be constant and independent of call characteristics and/or configuration settings received from a base station.

After the IMS 606 receives the configuration information from the LTE/NR modem 614, the IMS 606 may transmit a configuration message to the audio function 502. The configuration message may include a transmit reference time, a receive reference time, and an audio exchange interval depending on the CDRX cycle length, where these times are based at least on the configuration information received from the LTE/NR modem 614. In some embodiments, the CDRX cycle length received from the modem may be provided directly from the IMS 606 to the audio function 502 as the audio exchange interval (e.g., Audio_Exchange_Interval) without modification. In embodiments in which the arrival of one or more packets is used to trigger modem wakeup, the transmit reference time may be based at least on the CDRX start time, modem wakeup time, and total uplink processing time (e.g., Tx_Ref_Time=CDRX_start−(UPO_CCST+UL_P″)=CDRX_start−(UL_P′+WUT+SR_OFF+UL_P″)=CDRX_start−(UL_P+WUT+SR_OFF),). In embodiments in which the modem wakeup time is scheduled independent from the arrival of one or more packets, the transmit reference time may be based at least on the CDRX start time and total uplink processing time (e.g., Tx_Ref_Time=CDRX_start−(UL_P+SR_OFF). The receive reference time may be based at least on the CDRX start time, the CDRX on duration time, and the total downlink processing time (e.g., Rx_Ref_Time=CDRX_start+(ODT+DL_P′+DL_P″)=CDRX_start+(ODT+DL_P)). If the downlink first transmission BLER (Block Error Rate) is higher than a threshold TH_{BLER} (e.g., TH_{BLER}=25%), the receive reference time may also include DL HARQ-RTT timer value and DL Retransmission timer value plus the overhead to send an ACK/NACK after receives a DL packet.

As described by the configuration communications between the LTE/NR modem 614, the IMS 606, and the audio function 502, the transmit reference time and receive reference time for a CDRX cycle may be defined by the configuration settings received from a base station and the inherent processing times of the LTE/NR modem 614. Thus, when a handover event occurs during an active VoIP call, the transmit and receive reference times may change based on the change in SR and CDRX configuration settings, therefore requiring resynchronization of one or both of the encoding and decoding audio timelines to optimize the implemented CDRX cycle.

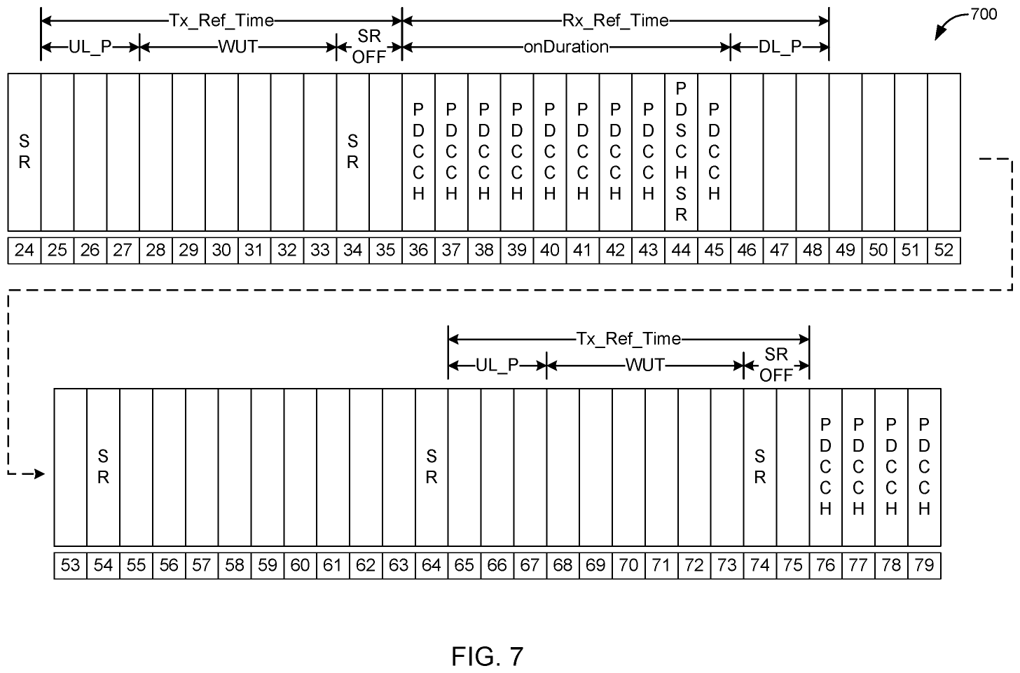

FIG. 7 illustrates an example CDRX timeline 700 of a wireless device according to various embodiments. The example CDRX timeline 700 is based on the transmit reference time, receive reference time, and audio exchange interval as described with respect to FIG. 6. In some embodiments, the audio exchange interval may be equal to or based on a CDRX cycle length. For example, the audio exchange interval may be equal to a CDRX cycle length configured by an eNB. The example illustrated implements a frequency division duplex (FDD) band. In some embodiments, a time division duplex (TDD) band may be implemented. For illustrative purposes, the time is provided in index (24 through 79 millisecond (ms)) rather than system frame number (SFN) and subframe. The CDRX timeline 700 describes a timeline implementing LTE technology, in which LTE-specific terms are used (e.g., sr-ConfigIndex). In some embodiments, the processes described in FIG. 7 may be used in NR FDD band implementations with 15 kHz sub-carrier spacing (SCS). In such embodiments, NR SR/CDRX configuration parameters may be configured in a same or similar manner as LTE configuration parameters (e.g., periodicityAndOffset=sl10:4 in SchedulingRequestResourceConfig IE for voice logical channel).

A VoIP call characteristic may be determined with the SR and CDRX configuration provided by the communicating eNB. For example, the eNB may have an sr-ConfigIndex of 9, which defines an SR periodicity of 10 ms and an SR offset of 4 ms. In other words, potential SR occasions may occur at times 4 ms, 14 ms, 24 ms, and so on. The CDRX may be configured as having a 40 ms cycle length with 36 ms offset and 10 ms onDuration, as shown from index 36 ms to 76 ms. The time indexed between the onDuration and the WUT may be the time that the wireless device is in a CDRX sleep mode to conserve power. Various embodiments provide for the wireless device to perform CDRX cycle resynchronization to maximize the time between the onDuration and the WUT while minimizing on or active times.

In this example, the CDRX start offset is illustrated to begin at 36 ms. The onDuration may be 10 ms, the wakeup time may be 6 ms, and the total uplink and downlink processing times may each be 3 ms (i.e., UL_P=3 ms and DL_P=3 ms). The selected SR occasion to request the uplink grant may be 2 ms ahead of the CDRX start (e.g., SR OFF occurs at 34 ms and 74 ms, 2 ms ahead of the CDRX start at 36 ms and 76 ms respectively). The following transmit reference time calculations assume that the arrival of one or more packets is used to trigger modem wakeup, and therefore the transmit reference time is based at least on the wakeup time. The transmit reference time may be determined using the following formula: Tx_Ref_Time=CDRX_start−(UL_P+WUT+SR_OFF). Thus, the voice frames from the audio function for CDRX cycles that start at time index 36 ms should be available for IMS (RTP layer) at time index Tx_Ref_Time=36 ms−(3 ms+6 ms+2 ms)=36 ms−11 ms=25 ms. The voice frames from the audio function for CDRX cycles that start at time index 76 ms should be available for IMS (RTP layer) at time index Tx_Ref_Time=76 ms−11 ms=65 ms. The time voice frames available for decoding may be equal to Rx_Ref_Time=CDRX_start+(onDuration+DL_P). Thus, the voice frames for the CDRX cycle that starts at time index 36 ms should be available for decoding at time index Rx_Ref_Time=36 ms+(10 ms+3 ms)=36 ms+13 ms=49 ms. Subsequently, the voice frames for the CDRX cycle that starts at time index 76 ms should be available for decoding at time index Rx_Ref_Time=76 ms+13 ms=89 ms.

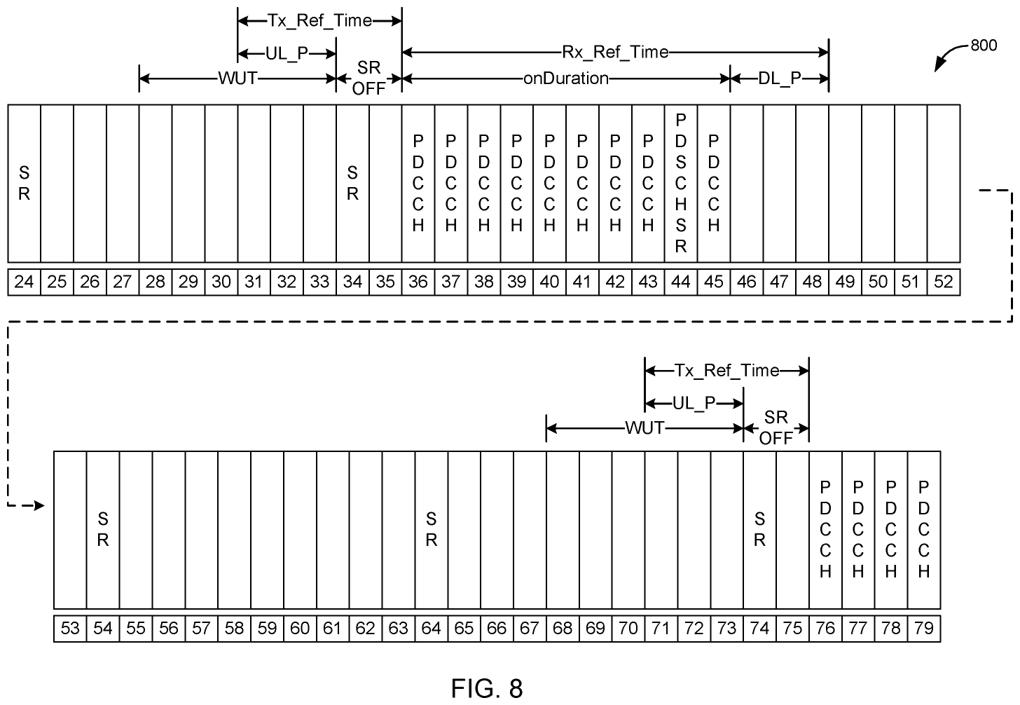

FIG. 8 illustrates an example CDRX timeline 800 of a wireless device according to various embodiments. The illustrated example implements an FDD band; however, in some embodiments, a TDD band may be implemented. In some embodiments, the audio exchange interval may be equal to or based on a CDRX cycle length. For example, the audio exchange interval may be equal to a CDRX cycle length configured by an eNB. The audio exchange interval as described with reference to FIG. 8 may be the same audio exchange interval as described with reference to FIG. 7. As described above, some CDRX implementations may schedule the modem wakeup time without requiring the actual arrival of the packet(s) from the audio function 502, such as knowing an UL transmission beforehand, or configuring the modem wakeup time by default against the selected SR occasion or CDRX start time, whichever is sooner. The CDRX timeline 800 may schedule the modem wakeup time independent of receiving any packets. The CDRX timeline 800 describes a timeline implementing LTE technology, in which LTE-specific terms are used (e.g., sr-ConfigIndex). In some embodiments, the processes described in FIG. 8 may be used in NR FDD band implementations with 15 kHz SCS, in which case the NR configuration parameters may be configured in a same or similar manner as LTE configuration parameters (e.g., periodicityAndOffset=sl10:4 in SchedulingRequestResourceConfig IE for voice logical channel).

In the CDRX timeline 800, the transport function may schedule the modem wakeup time without relying on the actual arrival of the packet(s) from the audio function at the modem. For example, the transport function may be aware of an uplink transmission beforehand, or by default, configure the modem wakeup time against the selected SR occasion or CDRX start time, whichever time is sooner within a CDRX timeline. The CDRX timeline 800 may be based on the same configuration settings as described with reference to the example CDRX timeline 700 of FIG. 7, except the modem wakeup time may be independent of the actual arrival of the packets at the modem. The CDRX timeline 800 differs from the CDRX timeline 700 in that the voice frames from the audio function for CDRX cycles that start at time indexes 36 and 76 should be available for the IMS (RTP layer) at time indexes Tx_Ref_Time=CDRX_start−(SR_OFF+UL_P)=36 ms−(2 ms+3 ms)=31 ms and 76 ms−(2 ms+3 ms)=71 ms, respectively, which results in less mouth-to-ear delay and a gain in overall power reduction.

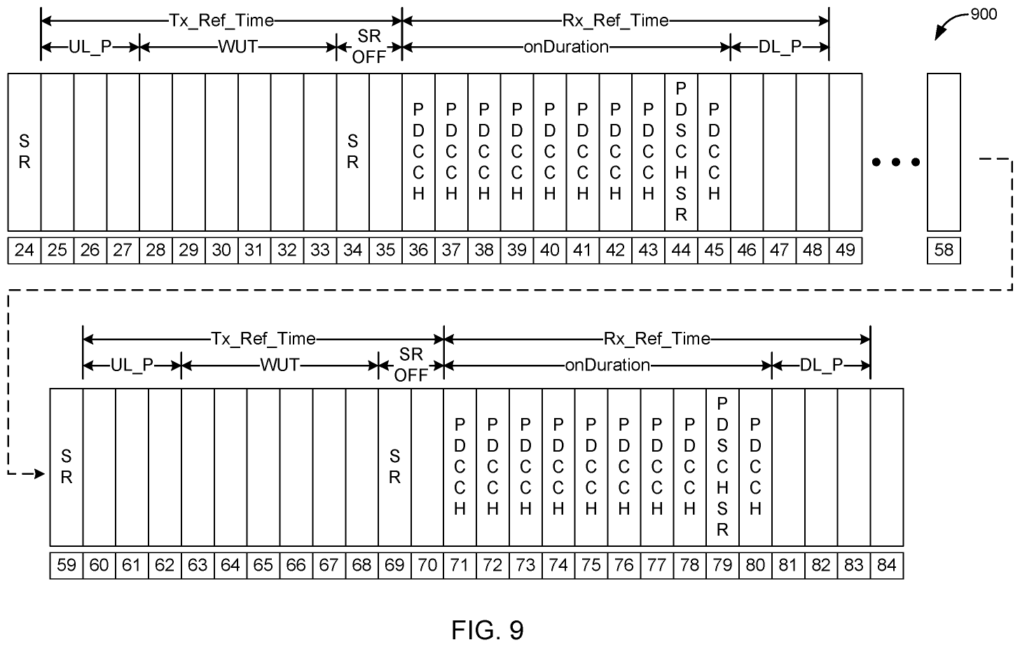

FIG. 9 illustrates an example unsynchronized CDRX timeline 900 of a wireless device experiencing a base station handover event according to various embodiments. The example in FIG. 9 illustrates Tx_Ref_Time and Rx_Ref_Time changes due to a handover event. The illustrated example implements an FDD band; however, in some embodiments, a TDD band may be implemented. The example illustrated in FIG. 9 also shows the VoIP timeline over an NR FDD band with 15 kHz sub-carrier spacing with the same CDRX configuration and periodicityAndOffset=sl10:4 in SchedulingRequestResourceConfig IE for the voice logical channel. Various embodiments may allow for a wireless device to perform resynchronization of CDRX cycles based on a wakeup time, as described with reference to FIG. 7, or independent of a wakeup time, as described with reference to FIG. 8. FIG. 9 illustrates an example unsynchronized CDRX timeline 900 in which a transmit reference time is based on a modem wakeup time, as illustrated in the examples illustrated by FIG. 7.

A CDRX timeline, such as unsynchronized CDRX timeline 900, may become unsynchronized when an active VoIP call experiences a handover event, transferring communications operations from one base station to another base station. The resulting change in SR and CDRX configuration information as preset by the base station may result in changes to the transmit and receive references times for a CDRX cycle. If the CDRX cycle length does not change, then the Audio_Exchange_Interval will remain the same.

The unsynchronized CDRX timeline 900 depicts a change in the transmit reference time (Tx_Ref_Time) and receive reference time (Rx_Ref_Time), as compared to CDRX timeline 700 as described with reference to FIG. 7. For example, the change in transmit and/or receive reference times may be the result of a base station handover event, such that the new base station performing CDRX VoIP operations has an SR configuration with 10 ms periodicity and 9 ms offset (sr-ConfigIndex=14), as opposed to 10 ms periodicity and 4 ms offset implemented by the previous base station (sr-ConfigIndex=9), and a CDRX start offset of 1 ms, instead of 36 ms, while other CDRX parameters remain the same. Thus, if a handover event occurred between CDRX cycle starts at index 36 and 76 of the first base station (a handover event may occur at any time during a CDRX cycle in the first base station), the CDRX cycle after the handover would start at 71 ms instead of 76 ms, the selected SR occasion after the handover would be at 69 ms instead of 74 ms, and the Tx_Ref_Time and Rx_Ref_Time after the handover would be at 60 ms and 84 ms instead of 65 ms and 89 ms. Therefore, without resynchronization of the voice coding timeline, the encoded frames will miss the SR at 69 ms. Instead, the SR occasion at 79 ms is used to request UL grant, which prolongs the wireless device on time and increases the delay for uplink transmission. In the downlink of the unsynchronized voice coding timeline, the received voice frames will remain in the de-jitter buffer longer (5 ms longer in this example) which results in longer DL delay. These delays and increased power usage will be repeated for any subsequent CDRX cycles. Therefore, resynchronizing the audio encoding and/or decoding timeline with the new CDRX configuration and SR configuration is beneficial for minimizing device on time and reducing audio mouth-to-ear delay. However, the resynchronization may cause multiple voice frames to be interrupted (e.g., three voice frames) on the uplink if the user is talking and/or the downlink if the user is listening and the remote user is talking, which causes audible voice quality degradation to the remote user if interruption occurs on uplink while the local user is talking or to the local user if interruption occurs on downlink while the remote user is talking.

Various embodiments allow for wireless devices to resolve the aforementioned problems by performing CDRX voice coding timeline resynchronization when experiencing a handover event while achieving minimum impact to voice quality of an active VoIP communication. In some embodiments, encoding and decoding timelines may be resynchronized based on the speech frames, or lack thereof, being transmitted or received by a wireless device between a base station. Voice encoding and voice decoding operations may be decoupled so that the voice encoding timeline and the voice decoding timeline may be resynchronized and/or reconfigured independently from each other. If the audio exchange interval is changed after a handover, such as due to the in-sync resynchronization between the encoding timeline and decoding timeline, the audio exchange interval on transmit side may not be identical to the audio exchange interval on receive side until both encoding timeline and decoding timeline are resynchronized with the connected base station.

In some embodiments, call characteristics (e.g., SR configuration, CDRX configuration, the selected SR occasion to request voice uplink grand, the offset of the selected SR occasion with respect to the CDRX start time (SR_OFF), voice encoding/transmit reference times, voice decoding/receive reference times, audio exchange interval, etc.) may be used to determine if and when resynchronization should be performed to maximize power conservation and minimize audio delay. In some embodiments, to eliminate potential audible voice quality degradation on either or both sides, wireless device may utilize characteristics of a typical VoLTE/VoNR call to determine an optimal time within a certain time to actually perform audio coding timeline resynchronization. For example, a wireless device may monitor or otherwise determine when one user of the wireless device is talking and another user of another wireless device on the call is listening, and vice versa, with the additional possibility of monitoring for intervals when both users are listening and not talking. In some embodiments, a wireless device may determine that DTX has been enabled in a VoLTE/VoNR call, such that when the user is listening, the encoded voice frame is either SID or NO_DATA, and NO_DATA frame is not transmitted (i.e. the audio encoder generates SID or NO_DATA as long as the user is not talking). When another is not talking, the device receives SID frames. The voice decoding timeline may be resynchronized if the user is talking and the other side is listening or both sides are listening, and the voice encoding timeline may be resynchronized if the user is listening or both sides are listening. Thus, audio encoding and decoding timelines may be resynchronized independent of each other and without audio data loss while optimizing the CDRX device low-power state times and normal-power state times to achieve maximum power conservation and minimum audio end-to-end delay.

In some embodiments, if the wireless device is unable to determine whether a user is talking, listening, and/or both users are listening based on monitoring the uplink and downlink for audio data frames, resynchronization of the encoding and/or decoding timelines may be performed regardless. For example, if the wireless device is unable to determine an ideal time to perform resynchronization (e.g., both users are continuously talking, too much background noise, DTX is disabled, etc.), resynchronization may be performed regardless of user voice activity after a configurable time. For example, the wireless device may determine that resynchronization should be performed after a handover event, may determine that resynchronization may not be presently ideal to perform such that it may interrupt audio, but may perform resynchronization of the encoding and/or decoding timelines regardless after a predefined time.

The transport function may determine when the audio function should perform the timeline resync and how much to adjust the timeline by providing the updated Tx_Ref_Time, Rx_Ref_Time, and Audio_Exchange_Interval. When receiving an indication for voice coding timeline resynchronization (i.e. voice encoding timeline resynchronization, voice decoding timeline resynchronization, or both), the audio function may complete the request resynchronization within some time T ms (e.g., T=60 ms). After the reception of these update parameters, the audio function should react within T ms according to the configuration parameters.

In some embodiments, a good, or ideal, voice coding timeline resynchronization may describe a resynchronization scenario in which the transport function configures (i) the voice encoding timeline resynchronization while it is able to detect that a local user of a wireless device is listening or that both sides (i.e. both users of both communicatively connected wireless devices) are not talking, or (ii) voice decoding timeline resynchronization while it is able to detect that the user is talking and the other remote user is listening or that both sides are not talking.

In some embodiments, a timer can be generated and configured by a wireless device for setting a minimum wait time to observe a good voice coding timeline resynchronization scenario as described by embodiments. For example, a Wait_Good_Re-sync_Timer may be implemented to denote the minimum wait time for the transport function to configure a ‘good’ voice encoding or voice decoding timeline resynchronization after a base station handover or some other event that may result in a change of one or more of the related SR and/or CDRX configuration parameters.

In some embodiments, a hard voice coding timeline resynchronization may describe a resynchronization scenario in which the transport function configures (i) voice encoding timeline resynchronization while it is unable to conclude that the user is listening or that both sides are not talking, or (ii) voice decoding timeline resynchronization while it is unable to conclude that the user is talking and the other side is listening or that both sides are not talking. In some embodiments, a timer can be generated and configured by a wireless device for setting a total wait time to observe a hard voice coding timeline resynchronization scenario. For example, a Hard_Re-sync_Prohibited_Timer may be implemented to denote the minimum interval between two consecutive hard audio timeline resynchronizations. Implementing a “backup” or failsafe resynchronization timer may allow a wireless device to ensure resynchronization is performed if a good resynchronization cannot be performed within a timeframe (i.e., hard coding timeline resynchronization is performed if and only if both Wait_Good_Re-sync_Timer and Hard_Re-sync_Prohibited_Timer are expired).

In some embodiments, a good resync timer (e.g., Wait_Good_Re-sync_Timer) and a hard resync timer (e.g., Hard_Re-sync_Prohibited_Timer) may be configurable and/or set to default predetermined time values. For example, the good resync timer may be set to a default value of 5 seconds and the hard resync timer may be set to a default value of 300 seconds. In some embodiments, the good resync timer and/or hard resync timer may be counters that may count down from or count up to configurable values. In some embodiments, the good resync timer and/or the hard resync timer may be configured in real-time by an algorithm, machine-learning, neural networks, or other artificial intelligence capable of determining an optimized timer value based on a number of factors including speech recognition patterns, accents and dialects, wireless device location, and delays between transmitted and received speech frames as monitored by the audio function. For example, the Wait_Good_Re-sync_Timer may be dynamically updated during a call based on the learned conversational pattern. Further, the value of the Wait_Good_Re-sync_Timer on the uplink (local user talk pattern) can be different than on the downlink (remote user talk pattern). Similarly, the Hard_Re-sync_Prohibited_Timer may be dynamically updated during a call based on the frequency of the resync triggering event and/or the estimated VoIP quality at both sides. For example, if the estimated voice quality on one or both sides is already bad, then the Hard_Re-sync_Prohibited_Timer may be increased. Otherwise, it may be reduced. Further, the value of the Hard_Re-sync_Prohibited_Timer on the uplink can be different than on the downlink. A hard resync timer may be implemented to ensure two consecutive hard resynchronizations on each direction (i.e. encoding and decoding timeline directions) are not performed too close in time. In some embodiments, a hard resync timer for a particular coding timeline direction may be reinitialized to a Hard_Re-sync_Prohibited_Timer value only when a hard resync is performed on that coding timeline direction.

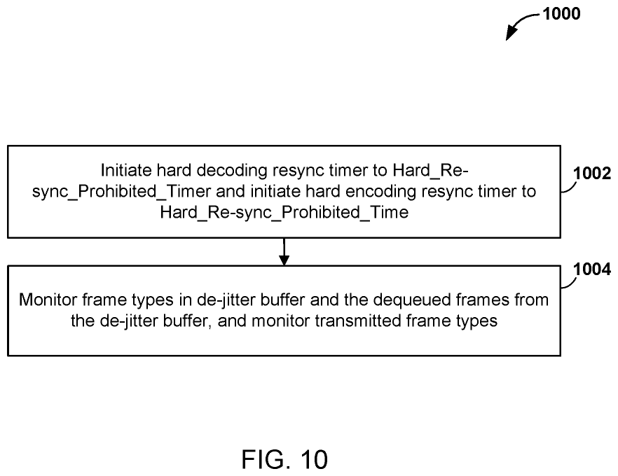

FIG. 10 is a process flow diagram illustrating a method 1000 for monitoring frame types for determining when to resynchronize a decoding timeline of VoIP communications according to some embodiments. With reference to FIGS. 1-10, the operations of the method 1000 may be performed by a processor (e.g., processor 210, 212, 214, 216, 218, 252, 260, 422) of a wireless device (e.g., the wireless device 120a-120e, 200, 320).

The order of operations performed in blocks 1002 and 1004 is merely illustrative, and the operations of blocks 1002 and 1004 may be performed in any order and partially simultaneously in some embodiments. In some embodiments, the method 1000 may be performed by a processor of a wireless device independently from, but in conjunction with, a processor of a network server or base station. For example, the method 1000 may be implemented as a software module executing within a processor of an SoC or in dedicated hardware within an SoC that monitors data and commands from/within the server and is configured to take actions and store data as described. In some embodiments, a processor of a wireless device may perform operations related to an audio and transport functions (e.g., audio function 502, transport function 504). For ease of reference, the various elements performing the operations of the method 1000 are referred to in the following method descriptions as a “processor.”

In block 1002, the processor may perform operations including initiating a hard decoding resync timer and initiating a hard encoding resync timer. The processes described in block 1002 may be performed after a voice call setup or a voice call resume (i.e. following a voice call hold). For example, after a call setup or call resume, a hard decoding resync timer (e.g., T_{HD}) may be configured to be equal to or set to a predefined or configurable value of a Hard_Re-Sync_Prohibited_Timer, and a hard encoding resync timer (e.g., T_{HE}) may be configured to be equal to or set to a predefined or configurable value of a Hard_Re-Sync_Prohibited_Timer. Initiating a hard decoding resync timer and/or a hard encoding resync timer may include beginning to count up or down to a timer expiration (e.g., set value, zero). For example, the hard decoding and encoding resync timers may be initiated to Hard_Re-sync_Prohibited_Timer, and may start counting at the call setup or call resume. During the call, the hard decoding resync timer and the hard encoding resync timer continue to run until expiration. The hard decoding resync timer will not be reset/reinitiated until a hard resynchronization of the decoding timeline is performed, and the hard encoding resync timer will not be reset/reinitiated until a hard resynchronization of the encoding timeline is performed. Once a reset or reinitiating of the hard encoding resync timer is performed, the hard encoding resync timer may again count up or count down to a timer expiration.

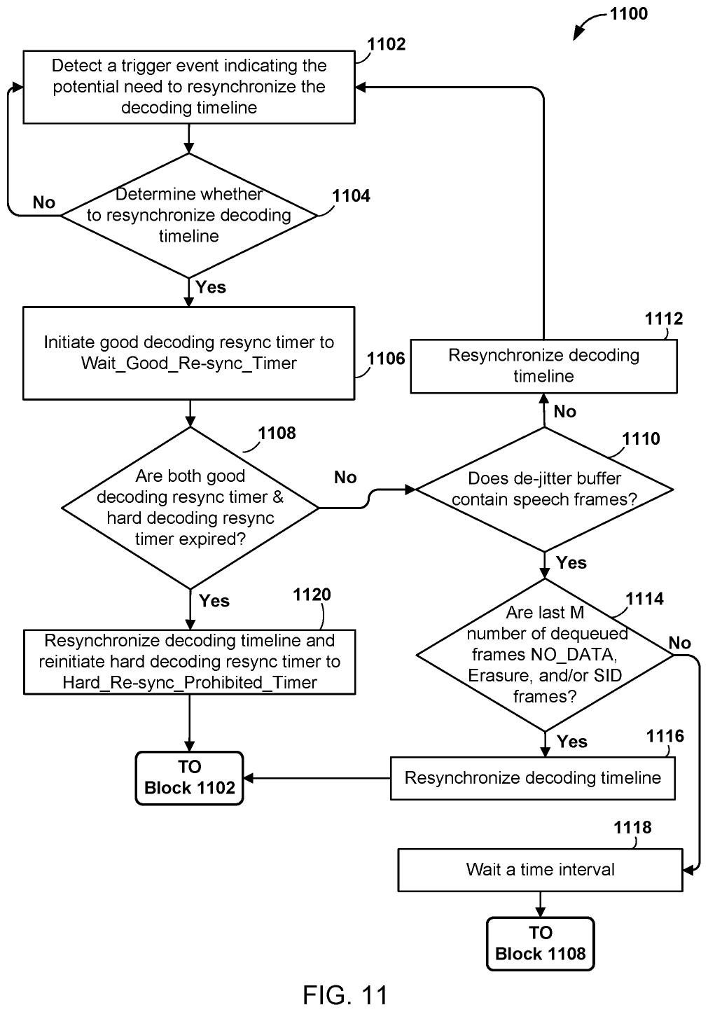

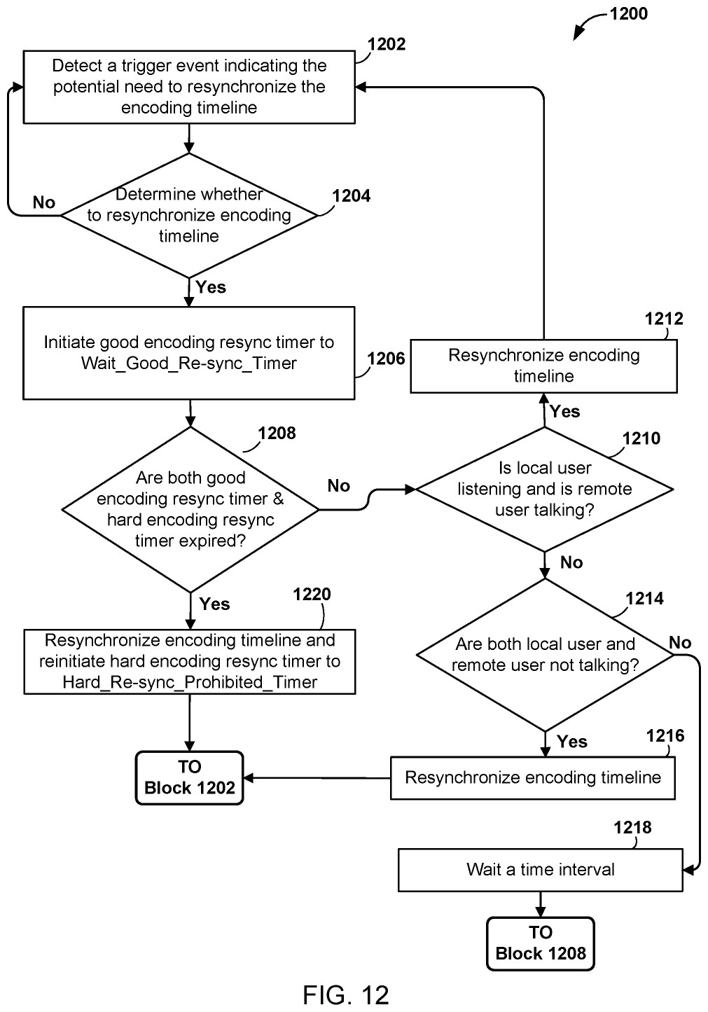

In block 1004, the processor may perform operations including monitoring frame types in a de jitter buffer, the frame types of the dequeued frames from the de-jitter buffer, and the frame types of the transmitted frames. The processor of the wireless device may analyze a de-jitter buffer (e.g., de-jitter buffer 510) to determine whether resynchronization of the encoding timeline should be performed to optimize VoIP communications. The processor of the wireless device may continuously monitor frame types in the de jitter buffer, the dequeued frames from the de-jitter buffer, and the transmitted frame types after the call is established or call resume. For example, the processor may continuously monitor frame types while simultaneously performing the processes described in FIGS. 11 and 12 for determining when to resynchronize a decoding timeline and an encoding timeline of VoIP communications.

FIG. 11 is a process flow diagram illustrating a method 1100 for determining when to resynchronize a decoding timeline of VoIP communications according to some embodiments. With reference to FIGS. 1-11, the operations of the method 1100 may be performed by a processor (e.g., processor 210, 212, 214, 216, 218, 252, 260, 422) of a wireless device (e.g., the wireless device 120a-120e, 200, 320).

The order of operations performed in blocks 1102-1120 is merely illustrative, and the operations of blocks 1102-1120 may be performed in any order and partially simultaneously in some embodiments. In some embodiments, the method 1100 may be performed by a processor of a wireless device independently from, but in conjunction with, a processor of a network server or base station. For example, the method 1100 may be implemented as a software module executing within a processor of an SoC or in dedicated hardware within an SoC that monitors data and commands from/within the server and is configured to take actions and store data as described. In some embodiments, a processor of a wireless device may perform operations related to an audio and transport functions (e.g., audio function 502, transport function 504). For ease of reference, the various elements performing the operations of the method 1100 are referred to in the following method descriptions as a “processor.”

In block 1102, the processor may perform operations including detecting a trigger event indicating the potential need to resynchronize the decoding timeline. A trigger event may include a handover event, such as switching control of VoIP communications from one base station to another base station. The most common event is intra-RAT handovers, such as between eNBs or between gNBs, or inter-RAT handovers, such as between a gNB and an eNB. However, a trigger event may also include a non-handover trigger event, such as when implementing new call characteristics (e.g., radio condition variation) while maintaining an active voice call. For example, a non-handover trigger event may occur when detecting that, within the same cell, the eNB changes the CDRX configuration and/or SR configuration.

In some embodiments, the processor of the wireless device may continuously monitor to detect a trigger event. For example, the processor may continuously monitor to detect any trigger events that may occur when simultaneously performing the processes in blocks 1104 through 1120 as described. For example, once the processor determines that a resync is needed, the execution of the logic in FIG. 11 may continue to be performed until operations in blocks 1112, 1116, 1118, or 1120 are performed or a new trigger event occurs. Detecting that a new trigger event occurred may cause the processor to interrupt the current processes being performed to restart the processes beginning in block 1104. For example, while in the middle of executing the operations in block 1112, another handover may occur, and in response the processor may stop the current processes in block 1112 to restart the operations in block 1104.

To illustrate, consider an example in which the Hard_Re-sync_Prohibited_Timer is 100 seconds, a user initiates a call in a first base station at time T (hard resync timer begins initiating/counting at time T), 20 seconds after beginning the call, a handover event occurs and control of the voice call transitions from the first base station to a second base station, and then 20 seconds after that and before a good resync to the second base station can be performed, another handover event may occurs, transitioning control of the voice call to a third base station. In this example situation, the processor needs to compare the call characteristics of the third base station with the call characteristics of the first base station to determine whether a resync with the third base station is needed.

In determination block 1104, the processor may perform operations including determining whether to resynchronize the decoding timeline. The processor may determine that resynchronization should be performed to optimize VoIP communications by analyzing and comparing call characteristics from before a base station handover event with call characteristics from after the base station handover event. For example, after a base station handover event, the base station (e.g., eNB/gNB) may provide new CDRX and/or SR configuration parameters to the wireless device, which may result in a new receive reference time and/or a new audio exchange interval. Thus, the wireless device may determine resynchronization of a decoding timeline should be performed by detecting whether a CDRX cycle length, CDRX offset time, onDuration timer, DL HARQ-RTT timer value, and/or DL retransmission timer value has changed. Additionally, the wireless device may determine that resynchronization of a decoding timeline should be performed by determining that a previous receive reference time and/or audio exchange interval associated with the previous base station is different from a current receive reference time and/or audio exchange interval associated with the current base station. Resynchronization may be performed in response to determining that one or more call characteristics have changed. In some embodiments, resynchronization may be performed in response to determining that one or more call characteristics exceed a threshold range. For example, despite one or more call characteristics changing as a result of a handover event, the resynchronization may not be performed if the changing is within an acceptable threshold range.

In response to determining that the decoding timeline should not be resynchronized, (i.e., determination block 1104=“No”), the processor may perform operations including detecting a trigger event indicating the potential need to resynchronize the decoding timeline in block 1102 as described.

In response to determining that the decoding timeline should be resynchronized, (i.e., determination block 1104=“Yes”), the processor may perform operations including configuring and initiating the good decoding resync timer in block 1106 as described. Initiating a good decoding resync timer may include beginning to count up or down to a timer expiration (e.g., set value, zero).

Once resynchronization is determined to be performed to optimize VoIP communications, the good decoding resync timer may be configured and initialized, indicating a timeline in which a good decoding timeline resynchronization may be performed. A good, or ideal, decoding timeline resynchronization may include performing resynchronization when a local user of a wireless device is talking and the remote user is listening, and/or when both users are listening, such that performing resynchronization of the decoding timeline at these times will not degrade local user received audio quality or user experience.

For example, a good decoding resync timer (e.g., T_{D}) may be configured to be equal to or set to a predefined or configurable value of a Wait_Good_Re-sync_Timer. When the transport function (e.g., transport function 504) of the wireless device concludes that voice decoding timeline resynchronization is required, timer T_{D} is initiated with a Wait_Good_Re-sync_Timer value.

In determination block 1108, the processor may perform operations including determining whether both the good decoding resync timer and the hard decoding resync timer are expired. Expiration of both these two resync timers may indicate that a timeframe in which a good, ideal, or safe resynchronization may be performed has passed. In some embodiments, the determination of whether both these two resync timer have expired may be performed simultaneously with processes described in blocks 1110 through 1118, such that expiration of these two resync timers may interrupt the processes described in blocks 1110 through 1118 to proceed to determination block 1120.

In response to determining that at least one of the good decoding resync timer and the hard decoding resync timer is not expired, (i.e., determination block 1108=“No”), the processor may perform operations including determining whether the de-jitter buffer contains speech frames in determination block 1110 as described. Determining that the de jitter buffer does not contain speech frames may indicate that decoding timeline resynchronization may be performed without degrading received VoIP quality. Determining that the de jitter buffer does contain speech frames may indicate that resynchronization may not be performed without degrading received VoIP quality, and further analysis should be performed to determine if a good, or ideal resynchronization may be performed (i.e. in determination block 1114 as described). The lack of speech frames detected within the de jitter buffer may indicate that a remote user of a remote connected wireless device is listening while a local user of the local wireless device is talking, or both users are listening, in which the lack of speech frames in the de jitter buffer may indicate that resynchronization of the decoding timeline may be performed without degrading the quality of the ongoing call.

In response to determining that the de-jitter buffer does not contain speech frames (i.e., determination block 1110=“No”), the processor may perform operations including resynchronizing the decoding timeline in block 1112 as described. For resynchronizing a decoding timeline, when the wireless device detects that the de jitter buffer is empty or contains SID frames only (i.e. the remote user is not talking), the VoIP decoding timeline may be immediately resynchronized, and the transport function may dequeue NO_DATA and SID as is and retain any newly received speech frame(s) in the de jitter buffer until resynchronization is complete.

In response to determining that the de-jitter buffer does contain speech frames (i.e., determination block 1110=“Yes”), the processor may perform operations including determining whether any number (“M” number) of recent dequeued frames are NO_DATA, Erasure, and/or SID frames in determination block 1114 as described. The processor may be configured to analyze a number of queued frames to determine if any of those most recently dequeue frames are frame types other than NO_DATA, Erasure, and/or SID frames, and are therefore speech frames. The presence of frame types other than NO_DATA, Erasure, or SID frames (e.g., speech frames) within some number M of recently dequeued frames may indicate that decoding timeline resynchronization may not be performed without affecting the VoIP communications quality.

In response to determining that any M number of recent dequeued frames are not NO_DATA, Erasure, and/or SID frames (i.e., determination block 1114=“No”), the processor may perform operations including waiting an interval of time in block 1118 as described. The processor may wait a period Tᵢₙₜ of time (e.g., 20 ms) before continuing on to again determine whether both the good decoding resync timer and the hard decoding resync timer are expired in determination block 1108 as described. If the processor determines that any number M of the most recently-dequeued frames are frame types other than NO_DATA, Erasure, or SID frames, the processor may wait some interval of time before again performing the operations in block 1108 to restart the processes described in blocks 1108 through 1118 for determining if and when a good, or ideal, decoding timeline resynchronization may be performed such that the user of the receiving wireless device would not perceive any (additional) audible audio interruption.

In response to determining that any M number of recent dequeued frames are NO_DATA, Erasure, and/or SID frames (i.e., determination block 1114=“Yes”), the processor may perform operations including resynchronizing the decoding timeline in block 1116 as described. For resynchronizing a decoding timeline, when the wireless device detects that the de jitter buffer contains speech frames but the last M number (e.g., M≥3) or more of consecutively dequeued frames are NO_DATA, Erasure, or SID frames, the VoIP decoding timeline may be immediately resynchronized, and any speech frames may be withheld and not dequeued (i.e. provide NO_DATA, Erasure, or SID if available in the head of line of the de-jitter buffer) until resynchronization is complete. In this case, if the last M number or more dequeued frames are NO_DATA or SID frames, decoding timeline resynchronization would not cause any audible audio interruption to the user. If the last M number dequeued frames also include Erasure, decoding timeline resynchronization would not worsen the audio quality to the user.

In response to determining that both the good decoding resync timer and the hard decoding resync timer are expired (i.e., determination block 1108=“Yes”), the processor may perform operations including resynchronizing the decoding timeline and reinitiating the hard decoding resync timer to Hard_Re-sync_Prohibited_Timer in block 1120 as described. For resynchronizing a decoding timeline, when both the good decoding resync timer (e.g., T_{D}) and the hard decoding resync timer (e.g., T_{HD}) have expired, the VoIP decoding timeline may be immediately resynchronized, the wireless device may dequeue any NO_DATA, Erasure, and SID as is, and retain existing and/or newly received speech frame(s) in the de-jitter buffer until resynchronization is complete.

FIG. 12 is a process flow diagram illustrating a method 1200 for determining when to resynchronize an encoding timeline of VoIP communications according to some embodiments. With reference to FIGS. 1-12, the operations of the method 1200 may be performed by a processor (e.g., processor 210, 212, 214, 216, 218, 252, 260, 422) of a wireless device (e.g., the wireless device 120a-120e, 200, 320).

The order of operations performed in blocks 1202-1220 is merely illustrative, and the operations of blocks 1202-1220 may be performed in any order and partially simultaneously in some embodiments. In some embodiments, the method 1200 may be performed by a processor of a wireless device independently from, but in conjunction with, a processor of a network server or base station. For example, the method 1200 may be implemented as a software module executing within a processor of an SoC or in dedicated hardware within an SoC that monitors data and commands from/within the server and is configured to take actions and store data as described. In some embodiments, a processor of a wireless device may perform operations related to an audio and transport functions (e.g., audio function 502, transport function 504). For ease of reference, the various elements performing the operations of the method 1200 are referred to in the following method descriptions as a “processor.”

In block 1202, the processor may perform operations including detecting a trigger event indicating the potential need to resynchronize the encoding timeline. A trigger event may include a handover event, such as switching control of VoIP communications from one base station to another base station. The most common events are intra-RAT handovers, such as between eNBs or between gNBs, and inter-RAT handovers, such as between a gNB and an eNB. However, a trigger event may also include a non-handover event, such as when implementing new call characteristics (e.g., radio condition variation) while maintaining an active voice call. For example, a non-handover trigger event may occur when detecting that, within the same cell, the eNB changes the CDRX configuration and/or SR configuration.

In some embodiments, the processor of the wireless device may continuously monitor to detect a trigger event. For example, the processor may continuously monitor to detect any trigger events that may occur when simultaneously performing the processes in blocks 1204 through 1220 as described. For example, once the processor determines that a resync is needed, the processor may continue executing the operations in the method 1200 (FIG. 12) until an operation in one of blocks1212, 1216, 1218, or 1220 is performed or a new trigger event occurs. Detecting that a new trigger event occurred may cause the processor to interrupt the current operations being performed to restart the method 1200 beginning in block 1204. For example, while in the middle of executing the operations in block 1212, another handover may occur, and the processor may stop the current processes in block 1212 to restart the logic at block 1204.

To illustrate, consider an example in which the Hard_Re-sync_Prohibited_Timer is 100 seconds, a user initiates a call in a first base station at time T (hard resync timer begins initiating/counting at time T), 20 seconds after beginning the call, a handover event occurs and control of the voice call transitions from the first base station to a second base station, and then 20 seconds after that and before a good resync to the second base station can be performed, another handover event may occurs, transitioning control of the voice call to a third base station. In this example situation, the processor needs to compare the call characteristics of the third base station with the call characteristics of the first base station to determine whether a resync with the third base station is needed.

In determination block 1204, the processor may perform operations including determining whether to resynchronize the encoding timeline. The processor may determine that resynchronization should be performed to optimize VoIP communications by analyzing and comparing call characteristics from before a base station handover event with call characteristics from after the base station handover event. For example, after a base station handover event, the base station (e.g., eNB/gNB) may provide new CDRX and/or SR configuration parameters to the wireless device, which may result in a new transmit reference time and/or a new audio exchange interval. Thus, the wireless device may determine resynchronization of an encoding timeline should be performed by detecting whether a CDRX cycle length, and/or CDRX offset time has changed and/or an SR periodicity and/or offset has changed. Additionally, the wireless device may determine that resynchronization of an encoding timeline should be performed by determining that a previous transmit reference time and/or audio exchange interval associated with the previous base station is different from a current transmit reference time and/or audio exchange interval associated with the current base station. Resynchronization may be performed in response to determining that one or more call characteristics has changed. In some embodiments, resynchronization may be performed in response to determining that one or more call characteristics exceed a threshold range. For example, despite one or more call characteristics changing as a result of a handover event, the resynchronization may not be performed if the changing is within an acceptable threshold range.

In response to determining that encoding timeline should not be resynchronized, (i.e., determination block 1204 =“No”), the processor may perform operations including detecting a trigger event indicating the potential need to resynchronize the encoding timeline in block 1202 as described.

In response to determining that encoding timeline should be resynchronized, (i.e., determination block 1204=“Yes”), the processor may perform operations including configuring and initiating the good encoding resync timer in block 1206. Initiating a good encoding resync timer may include beginning to count up or down to a timer expiration (e.g., set value, zero).

Once resynchronization is determined to be performed to optimize VoIP communications, the good encoding resync timer may be configured and initialized, indicating a timeline in which a good resynchronization may be performed. A good, or ideal, resynchronization may include performing resynchronization when a local user of a wireless device is not talking, or when both users are listening or not talking, such that performing resynchronization of encoding timeline at these times will not degrade transmitted audio quality.

For example, a good encoding resync timer (e.g., T_{E}) may be configured to be equal to or set to a predefined or configurable value of a Wait_Good_Re-sync_Timer. When the transport function (e.g., transport function 504) of the wireless device concludes that voice encoding timeline resynchronization is required, timer T_{E} is started with a Wait_Good_Re-sync_Timer value.

In determination block 1208, the processor may perform operations including determining whether both the good encoding resync timer and the hard encoding resync timer are expired. Expiration of both of these two resync timers may indicate that a timeframe in which a good, ideal, or safe resynchronization may be performed has passed. In some embodiments, the determination of whether both a good encoding resync timer and a hard decoding resync timer have expired may be performed simultaneously with processes in blocks 1210 through 1218, such that expiration of these two resync timers may interrupt the processes in blocks 1210 through 1218 to perform the operations in determination block 1220.

In response to determining that at least one of the good encoding resync timer and the hard encoding resync timer is not expired, (i.e., determination block 1208 =“No”), the processor may perform operations including determining whether a local user of the local wireless device is listening and the remote user is talking in determination block 1210. Determining whether a local user of the local wireless device is listening and the remote user is talking may include determining (i) that the last “Ni” number of frames from audio function are either NO_DATA or SID, and (ii) that the de jitter buffer contains one or more speech frame and the last “N2” dequeued frames are speech frames with or without erasures. Determining that conditions (i) and (ii) are satisfied may indicate that encoding timeline resynchronization may be performed without degrading transmitted VoIP quality. Determining that conditions (i) and (ii) are not satisfied may indicate that resynchronization may not be performed without degrading VoIP quality, and further analysis should be performed to determine if a good, or ideal resynchronization may be performed (i.e. in determination block 1214 as described).

In response to determining that the local user of the local wireless device is listening and the remote user is talking (i.e., determination block 1210=“Yes”), the processor may perform operations including resynchronizing the encoding timeline in block 1212. For resynchronizing an encoding timeline, when the wireless device detects that the last N1 number (e.g., N1=5) of consecutive uplink frames are either NO_DATA or SID frames, the de jitter buffer contains one or more speech frames, and the last N2 number (e.g., N2=6) of consecutively dequeued frames are speech frames with or without one or more erasures, the VoIP encoding timeline may be immediately resynchronized.

In response to determining that the local user of the local wireless device is not listening and the remote user is talking (i.e., determination block 1210=“No”), the processor may perform operations including determining whether both the local user of the local wireless device and a remote user of a connected remote wireless device are listening or not talking in determination block 1214. This may include determining that (i) the de-jitter buffer does not contain speech frames, (ii) the last transmitted talk spurt is at least “T₁” ms long, and (iii) the last transmitted speech frame was older than “T₂” ms but newer than “T₃” ms. When the wireless device detects that the de jitter buffer is empty or contains SID frames only, and the last uplink talk spurt was at least T₁ ms long and the last uplink speech frame was older than T₂ ms but newer than T₃ ms, the VoIP encoding timeline may be immediately resynchronized. Determining that conditions (i), (ii), and (iii) are satisfied may indicate that encoding timeline resynchronization may be performed without degrading transmitted VoIP quality. Determining that conditions (i), (ii), and (iii) are not satisfied may indicate that resynchronization may not be performed without degrading transmitted VoIP quality, and further analysis should be performed to determine if a good, or ideal resynchronization may be performed (i.e. wait longer for both users to stop talking by reperforming processes described in determination block 1208). In some embodiments, the values of T₁, T₂, and T₃ may be predefined (e.g., T₁=1 second, T₂=40 ms, and T₃=200 ms), configurable, or otherwise actively determined. For example, the wireless device may implement an algorithm, machine-learning, neural networks, or other artificial intelligence capable of determining optimized time values for T₁, T₂, and T₃ based on a number of factors including speech recognition patterns, accents and dialects, wireless device location, and delays between transmitted and received speech frames as monitored by the audio function.

In response to determining that the local user of the local wireless device may be talking and the remote user of the connected remote wireless device may be talking or listening (i.e., determination block 1214=“No”), the processor may perform operations including waiting an interval of time in block 1218 as described. The processor may wait a period Tᵢₙₜ of time (e.g., 20 ms) before continuing on to again determine whether both the good encoding resync timer and the hard encoding resync timer are expired in determination block 1208 as described.

In response to determining that both the local user of the local wireless device and the remote user of the connected remote wireless device are not talking (i.e., determination block 1214=“Yes”), the processor may perform operations including resynchronizing the encoding timeline in block 1216.

In response to determining that both the good encoding resync timer and the hard encoding resync timer are expired (i.e., determination block 1208=“Yes”), the processor may perform operations including resynchronizing the encoding timeline and reinitiating the hard decoding resync timer to Hard_Re-sync_Prohibited_Timer in block 1220. For resynchronizing an encoding timeline, when both the good encoding resync timer (e.g., T_{E}) and the hard encoding resync timer (e.g., T_{HE}) have expired, the VoIP encoding timeline may be immediately resynchronized. After resynchronization is complete, the processor may reset the hard encoding resync timer to Hard_Re-sync_Prohibited_Timer value if the uplink frames immediately before and immediately after the voice encoding timeline resynchronization are speech frames. After resynchronization is complete, the processor may reset the hard encoding resync timer to Hard_Re-sync_Prohibited_Timer without checking the transmitted frame types right before and right after resynchronization.

In this documents, the term “total wait time” refers to the timeframe from the initiation of a good encoding (or decoding) resync timer to expiration of both the good encoding (or decoding) resync timer and the hard encoding (or decoding) resync timer, in which the good encoding (or decoding) resync timer is initiated to a “minimum wait time.”

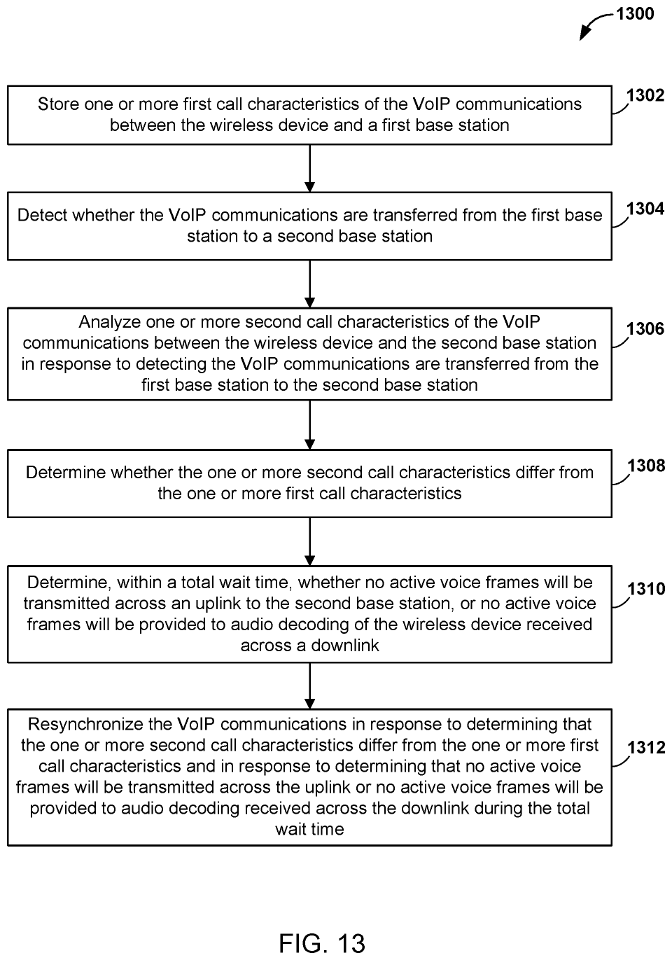

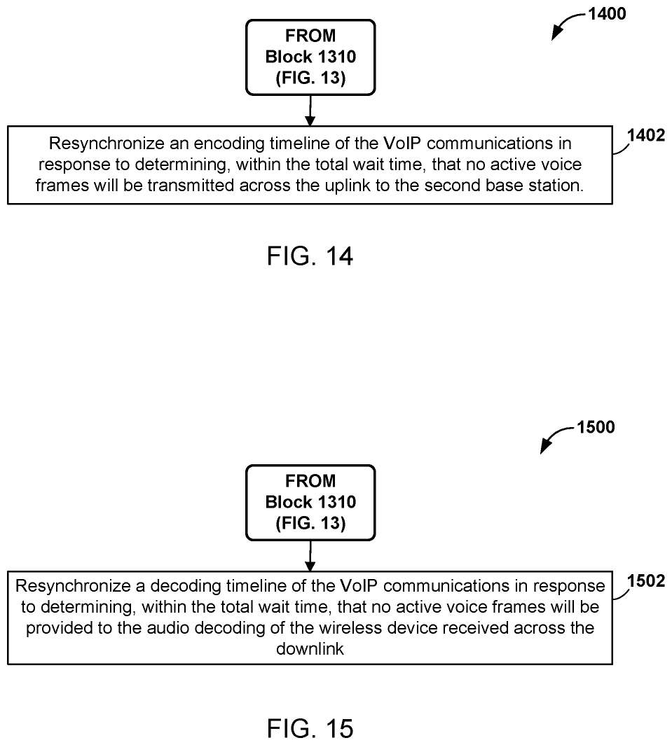

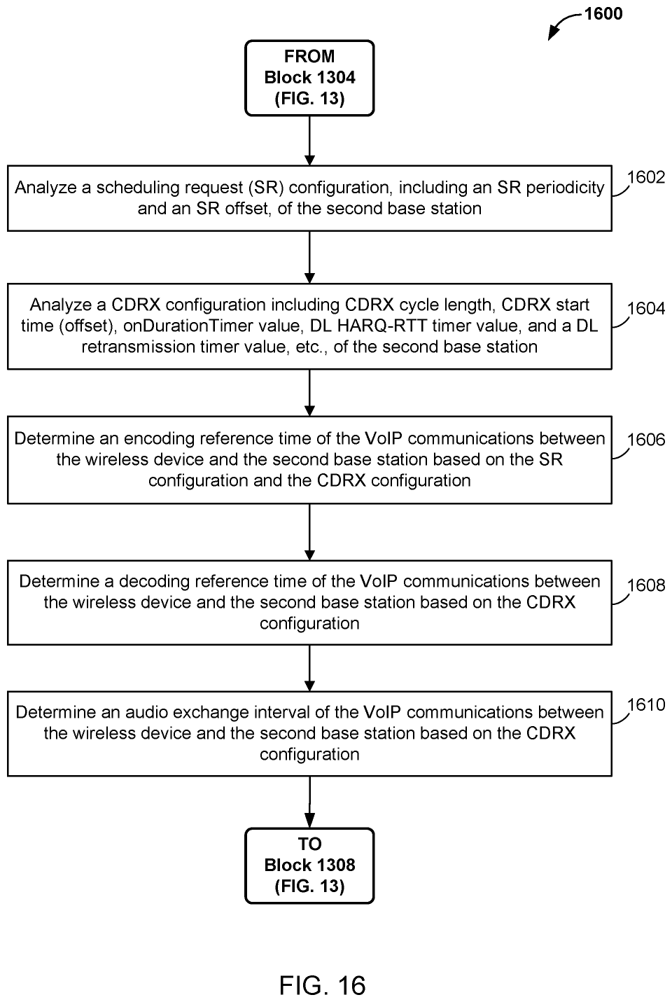

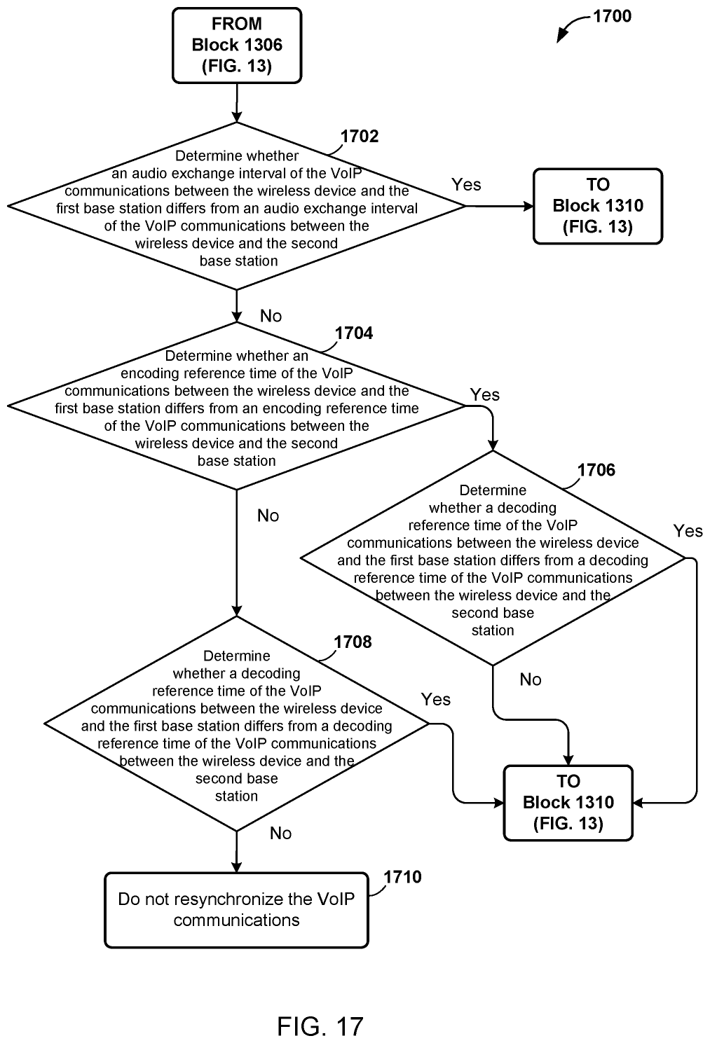

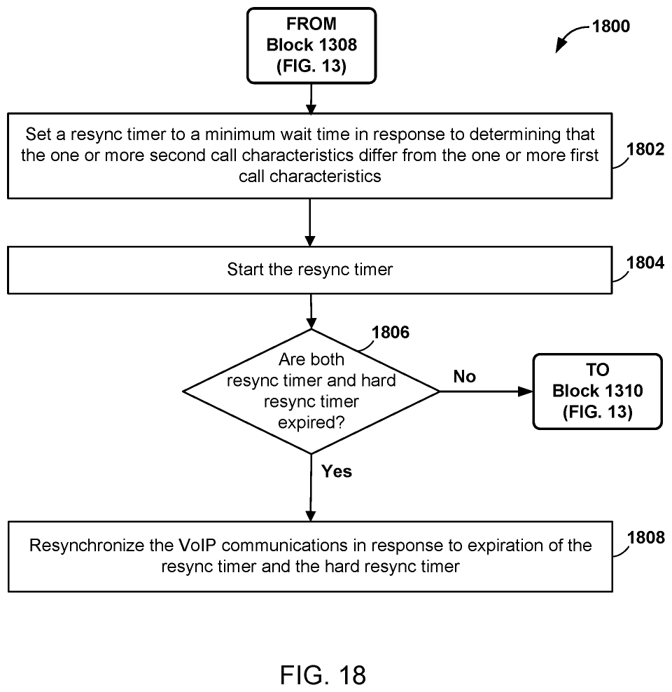

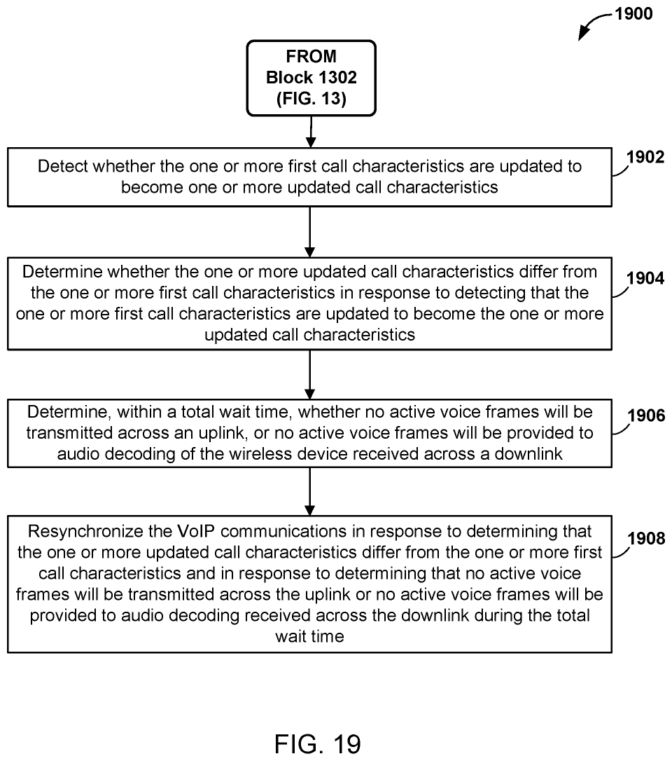

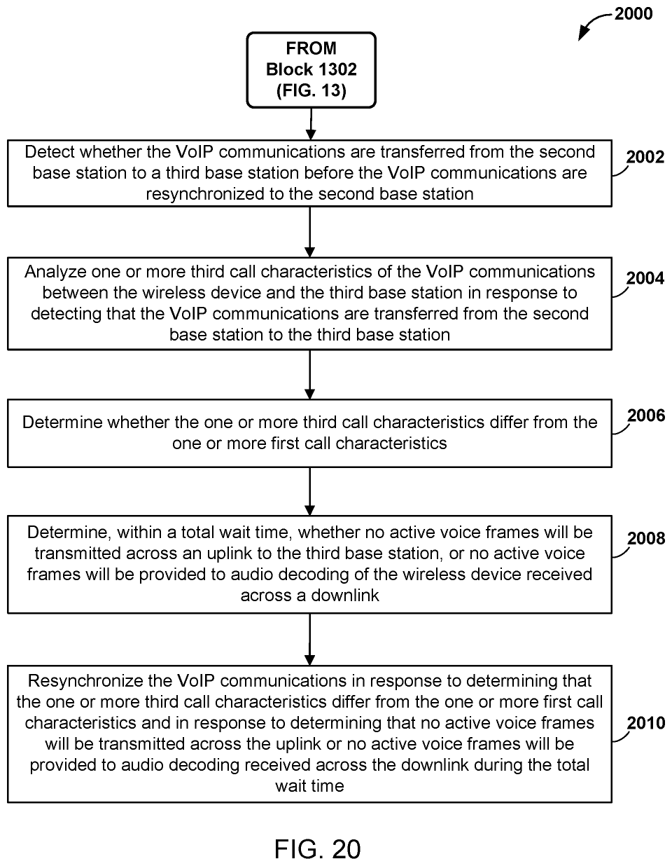

FIG. 13 is a process flow diagram illustrating a method 1300 implementing a processor of a wireless device for determining when to resynchronize VoIP communications of the wireless device according to some embodiments. With reference to FIGS. 1-13, the operations of the method 1300 may be performed by a processor (e.g., processor 210, 212, 214, 216, 218, 252, 260, 422) of a wireless device (e.g., the wireless device 120a-120e, 200, 320).

The order of operations performed in blocks 1302-1312 is merely illustrative, and the operations of blocks 1302-1312 may be performed in any order and partially simultaneously in some embodiments. In some embodiments, the method 1300 may be performed by a processor of a wireless device independently from, but in conjunction with, a processor of a network server or base station. For example, the method 1300 may be implemented as a software module executing within a processor of an SoC or in dedicated hardware within an SoC that monitors data and commands from/within the server and is configured to take actions and store data as described. For ease of reference, the various elements performing the operations of the method 1300 are referred to in the following method descriptions as a “processor.”

In block 1302, the processor may perform operations including storing one or more first call characteristics of the VoIP communications between the wireless device and a first base station.

In block 1304, the processor may perform operations including detecting whether the VoIP communications are transferred from the first base station to a second base station.

In block 1306, the processor may perform operations including analyzing one or more second call characteristics of the VoIP communications between the wireless device and the second base station in response to detecting the VoIP communications are transferred from the first base station to the second base station. Analyzing one or more call characteristics may include analyzing the SR configuration and CDRX configuration in the second base station, selecting the SR occasion to request uplink grant for voice uplink transmission in the second base station, and determining the transmit/encoding reference time (e.g., Tx_Ref_Time), receive/decoding reference time (e.g., Rx_Ref_Time), and audio exchange interval (e.g., Audio_Exchange_Interval), in which the audio exchange interval may typically be the CDRX cycle length configured by eNB/gNB in the second base station.

In block 1308, the processor may perform operations including determining whether the one or more second call characteristics differ from the one or more first call characteristics.

In block 1310, the processor may perform operations including determining, within a total wait time, whether no active voice frames will be transmitted across an uplink to the second base station, or no active voice frames will be provided to audio decoding of the wireless device received across a downlink.

In block 1312, the processor may perform operations including resynchronizing the VoIP communications in response to determining that the one or more second call characteristics differ from the one or more first call characteristics and in response to determining within the total wait time that no active voice frames will be transmitted across the uplink or no active voice frames will be provided to the audio decoding received across the downlink during the total wait time.

FIG. 14 is a process flow diagram illustrating alternative operations that may be performed by a processor of a wireless device as part of the method 1300 for determining when to resynchronize VoIP communications of the wireless device according to some embodiments. With reference to FIGS. 1-14, the operations of the method 1400 may be performed by a processor (e.g., processor 210, 212, 214, 216, 218, 252, 260, 422) of a wireless device (e.g., the wireless device 120a-120e, 200, 320).

Following the performance of the operations of block 1310 (FIG. 13), the processor may perform operations including resynchronizing an encoding timeline of the VoIP communications in response to deter mining within the total wait time in block 1302 that no active voice frames will be transmitted across the uplink to the second base station. In some embodiments, resynchronizing an encoding timeline of the VoIP communications may be performed by providing the audio function with the latest determined encoding/transmit reference time (e.g., an encoding reference time determined by the operations of block 1606 of the method 1600 (FIG. 16)), the latest determined audio exchange interval (e.g., an audio exchange interval determined by the operations of block 1610 of the method 1600 (FIG. 16)), and an indication to resynchronize the encoding timeline. This may be performed as part of the processes described in block 1312 (FIG. 13).

FIG. 15 is a process flow diagram illustrating alternative operations that may be performed by a processor of a wireless device as part of the method 1300 for determining when to resynchronize VoIP communications of the wireless device according to some embodiments. With reference to FIGS. 1-15, the operations of the method 1500 may be performed by a processor (e.g., processor 210, 212, 214, 216, 218, 252, 260, 422) of a wireless device (e.g., the wireless device 120a-120e, 200, 320).

Following the performance of the operations of block 1310 (FIG. 13), the processor may perform operations including resynchronizing a decoding timeline of the VoIP communications in response to determining, within the total wait time, that no active voice frames will be provided to the audio decoding of the wireless device received across the downlink in block 1502. In some embodiments, resynchronizing a decoding timeline of the VoIP communications may be performed by providing the audio function with the latest determined decoding/receive reference time (e.g., a decoding reference time determined by the operations of block 1608 of the method 1600 (FIG. 16)), the latest determined audio exchange interval (e.g., an audio exchange interval determined by the operations of block 1610 of the method 1600 (FIG. 16)), and an indication to resynchronize the decoding timeline. This may be performed as part of the operations in block 1312 of the method 1300 (FIG. 13).

FIG. 16 is process flow diagram illustrating alternative operations that may be performed by a processor of a wireless device as part of the method 1300 for determining when to resynchronize VoIP communications of the wireless device according to some embodiments. With reference to FIGS. 1-16, the operations of the method 1600 may be performed by a processor (e.g., processor 210, 212, 214, 216, 218, 252, 260, 422) of a wireless device (e.g., the wireless device 120a-120e, 200, 320).

Following performance of the operations of block 1304 of the method 1300 (FIG. 13), the processor may perform operations including analyzing a scheduling request (SR) configuration, including an SR periodicity and an SR offset, of the second base station in block 1602.

In block 1604, the processor may perform operations including analyzing a CDRX configuration including CDRX cycle length, CDRX start time (offset), onDurationTimer value, DL HARQ-RTT timer value, and a DL retransmission timer value, etc., of the second base station.

In block 1606, the processor may perform operations including determining an encoding reference time of the VoIP communications between the wireless device and the second base station based on the SR configuration and the CDRX configuration.

In block 1608, the processor may perform operations including determining a decoding reference time of the VoIP communications between the wireless device and the second base station based on the CDRX configuration.

In block 1610, the processor may perform operations including determining an audio exchange interval of the VoIP communications between the wireless device and the second base station based on the CDRX configuration.

FIG. 17 is process flow diagram illustrating alternative operations that may be performed by a processor of a wireless device as part of the method 1300 for determining when to resynchronize VoIP communications of the wireless device according to some embodiments. With reference to FIG. 1-17, the operations of the method 1700 may be performed by a processor (e.g., processor 210, 212, 214, 216, 218, 252, 260, 422) of a wireless device (e.g., the wireless device 120a-120e, 200, 320).

Following the performance of the operations of block 1306 of the method 1300 (FIG. 13), the processor may perform operations including determining whether an encoding reference time (e.g., transmit reference time, Tx_Ref_Time) of the VoIP communications between the wireless device and the first base station differs from an encoding reference time of the VoIP communications between the wireless device and the second base station, whether a decoding reference time (e.g., receive reference time, Rx_Ref_Time) of the VoIP communications between the wireless device and the first base station differs from a decoding reference time of the VoIP communications between the wireless device and the second base station, and/or whether an audio exchange interval (e.g., Audio_Exchange_Interval) of the VoIP communications between the wireless device and the first base station differs from an encoding/decoding reference timer interval of the VoIP communications between the wireless device and the second base station in determination blocks 1702-1708.

While the processes shown in FIG. 17 is illustrated as determination blocks having “Yes” and “No” outcomes for ease of illustration, it is important to note that a result of a “Yes” (i.e. call characteristics differ) does not preclude the remaining determination blocks from being performed, such that multiple determinations in determination blocks 1702-1708 may be performed before to the processor performs the operations in block 1310 or any further operations including determining that a resynchronization should not be performed. For example, determination block 1702 may result in a “Yes” determination, but before performing the operations in block 1310, determinations of at least one of the remaining determination blocks 1704-1708 may be performed to determine whether any additional call characteristics differ. At least one result of “Yes” from any of the determination blocks 1702-1708 may indicate that a resynchronization of the VoIP communications should be performed. A “No” result from all determination blocks 1702-1708 may indicate that resynchronization of the VoIP communications may not need to be performed. Depending on the outcome of each of the determination blocks 1702-1708, various operations may be performed to resynchronize the VoIP communications as described.

Following performance of the operations of block 1306 (FIG. 13), the processor may perform operations including determining whether an audio exchange interval (e.g., Audio_Exchange_Interval) of the VoIP communications between the wireless device and the first base station differs from an audio exchange interval of the VoIP communications between the wireless device and the second base station in determination blocks 1702.

In response to determining that an audio exchange interval of the VoIP communications between the wireless device and the first base station differs from an audio exchange interval of the VoIP communications between the wireless device and the second base station (i.e., determination block 1702=“Yes”), the processor may perform the operations of block 1310 of the method (FIG. 13) as described. In such cases, the operations of block 1310 may include performing an encoding timeline resynchronization with the latest determined encoding reference time (e.g., an encoding reference time determined by the operations of block 1606 of the method 1600 (FIG. 16)) and the latest determined audio exchange interval (e.g., an audio exchange interval determined by the operations of block 1610 of the method 1600 (FIG. 16)), and performing a decoding timeline resynchronization with the latest determined decoding reference time (e.g., a decoding reference time determined by the operations of block 1608 of the method 1600 (FIG. 16)) and the latest determined audio exchange interval.

In response to determining that an audio exchange interval of the VoIP communications between the wireless device and the first base station does not differ from an audio exchange interval of the VoIP communications between the wireless device and the second base station (i.e., determination block 1702=“No”), the processor may perform operations including determining whether an encoding reference time of the VoIP communications between the wireless device and the first base station differs from an encoding reference time of the VoIP communications between the wireless device and the second base station in determination block 1704.

In some embodiments, the audio exchange interval may not impact or otherwise have an effect on the audio coding timeline. In such embodiments, determining whether an audio exchange interval has changed may not be required for resynchronizing an audio encoding and/or decoding timeline. For example, in embodiments in which an audio exchange interval does not impact the audio coding timeline, the processes in block 1702 may be ignored or otherwise not performed. For example, the processes in blocks 1704-1708 may be performed as described without performing the processes in block 1702 when the audio exchange interval has no impact on the audio coding timeline.

In response to determining that an encoding reference time of the VoIP communications between the wireless device and the first base station differs from an encoding reference time of the VoIP communications between the wireless device and the second base station (i.e., determination block 1704=“Yes”), the processor may determine whether a decoding reference time (e.g., receive reference time, Rx_Ref_Time) of the VoIP communications between the wireless device and the first base station differs from a decoding reference time of the VoIP communications between the wireless device and the second base station in determination block 1706.

In response to determining that a decoding reference time of the VoIP communications between the wireless device and the first base station differs from a decoding reference time of the VoIP communications between the wireless device and the second base station (i.e., determination block 1706=“Yes”), the processor may perform the operations of block 1310 of the method (FIG. 13) as described. An outcome of “Yes” for both determination blocks 1704 and 1706 may indicate that both the encoding timeline and the decoding timeline should be resynchronized. Thus, when the outcome of determination block 1706=“Yes,” the operations of block 1310 may include performing an encoding timeline resynchronization with the latest determined encoding reference time and the latest determined audio exchange interval, and performing a decoding timeline resynchronization with the latest determined decoding reference and the latest determined audio exchange interval.

In response to determining that a decoding reference time of the VoIP communications between the wireless device and the first base station does not differ from a decoding reference time of the VoIP communications between the wireless device and the second base station (i.e., determination block 1706=“No”), the processor may perform the operations of block 1310 of the method (FIG. 13) as described. An outcome of “Yes” for determination block 1704 and an outcome of “No” for determination block 1706 may indicate that the encoding timeline should be resynchronized, but the decoding timeline should not be resynchronized. Thus, when the outcome of determination block 1706=“No,” the operations of block 1310 may include perform ling an encoding timeline resynchronization with the latest determined encoding reference time and the latest determined audio exchange interval.

In response to determining that an encoding reference time of the VoIP communications between the wireless device and the first base station does not differ from an encoding reference time of the VoIP communications between the wireless device and the second base station (i.e., determination block 1704=“No”), the processor may perform operations including determining whether a decoding reference time of the VoIP communications between the wireless device and the first base station differs from a decoding reference time of the VoIP communications between the wireless device and the second base station in determination block 1708.

In response to determining that a decoding reference time of the VoIP communications between the wireless device and the first base station differs from a decoding reference time of the VoIP communications between the wireless device and the second base station (i.e., determination block 1708=“Yes”), the processor may then proceed to perform the operations of block 1310 of the method (FIG. 13) as described. An outcome of “No” for determination block 1704 and an outcome of “Yes” for determination block 1708 may indicate that the decoding timeline should be resynchronized, but the encoding timeline should not be resynchronized. Thus, when the outcome of determination block 1708=“Yes,” the operations of block 1310 may include performing a decoding timeline resynchronization with the latest determined decoding reference time and the latest determined audio exchange interval.

In response to determining that a decoding reference time the VoIP communications between the wireless device and the first base station does not differ from a decoding reference time of the VoIP communications between the wireless device and the second base station (i.e., determination block 1708=“No”), the processor may perform operations including determining that resynchronization of the VoIP communications should not be performed in block 1710.

FIG. 18 is a process flow diagram illustrating alternative operations that may be performed by a processor of a wireless device as part of the method 1300 for determining when to resynchronize VoIP communications of the wireless device according to some embodiments. With reference to FIGS. 1-18, the operations of the method 1800 may be performed by a processor (e.g., processor 210, 212, 214, 216, 218, 252, 260, 422) of a wireless device (e.g., the wireless device 120a-120e, 200, 320).

Following the performance of the operations of block 1308 (FIG. 13), the processor may perform operations including setting a resync timer to a minimum wait time in response to determining that the one or more second call characteristics differ from the one or more first call characteristics in block 1802.

In block 1804, the processor may perform operations including starting the resync timer (e.g., good encoding resync timer/good decoding resync timer), wherein resynchronizing the VoIP communications occurs before expiration of the resync timer and a hard resync timer. In some embodiments, the total wait time may be a duration from a start time of the resync timer to the expiration of both the resync timer and the hard resync timer.

In determination block 1806, the processor may perform operations including determining whether both the resync timer and a hard resync timer (e.g., hard encoding resync timer/hard decoding resync timer) are expired.

In response to determining that both the resync timer and the hard resync timer are expired (i.e., determination block 1806=“Yes”), the processor may perform operations including resynchronizing the VoIP communications in response to expiration of the resync timer and the hard resync timer in block 1808.

In response to determining that either of the resync timer or the hard resync timer are not expired (i.e., determination block 1806=“No”), the processor may perform the operations of block 1310 of the method 1300 (FIG. 13) as described.

FIG. 19 is a process flow diagram illustrating alternative operations that may be performed by a processor of a wireless device as part of the method 1300 for determining when to resynchronize VoIP communications of the wireless device according to some embodiments. With reference to FIGS. 1-19, the operations of the method 1900 may be performed by a processor (e.g., processor 210, 212, 214, 216, 218, 252, 260, 422) of a wireless device (e.g., the wireless device 120a-120e, 200, 320).

After performing operations of block 1302 of the method 1300 (FIG. 13), the processor may perform operations including detecting whether the one or more first call characteristics are updated to become one or more updated call characteristics in block 1902.

In block 1904, the processor may perform operations including determining whether the one or more updated call characteristics differ from the one or more first call characteristics in response to detecting that the one or more first call characteristics are updated to become the one or more updated call characteristics.

In block 1906, the processor may perform operations including determining, within the total wait time, whether no active voice frames will be transmitted across an uplink, or no active voice frames will be provided to audio decoding of the wireless device received across a downlink.

In block 1908, the processor may perform operations including resynchronizing the VoIP communications in response to determining that the one or more updated call characteristics differ from the one or more first call characteristics and in response to determining that no active voice frames will be transmitted across the uplink or no active voice frames will be provided to audio decoding received across the downlink during the total wait time.

FIG. 20 is a process flow diagram illustrating alternative operations that may be performed by a processor of a wireless device as part of the method 1300 for determining when to resynchronize VoIP communications of the wireless device according to some embodiments. With reference to FIGS. 1-20, the operations of the method 2000 may be performed by a processor (e.g., processor 210, 212, 214, 216, 218, 252, 260, 422) of a wireless device (e.g., the wireless device 120a-120e, 200, 320).

After performing the operations of block 1302 of the method 1300 (FIG. 13), the processor may perform operations including detecting whether the VoIP communications are transferred from the second base station to a third base station before the VoIP communications are resynchronized to the second base station in block 2002.

In block 2004, the processor may perform operations including analyzing one or more third call characteristics of the VoIP communications between the wireless device and the third base station in response to detecting that the VoIP communications are transferred from the second base station to the third base station.

In block 2006, the processor may perform operations including determining whether the one or more third call characteristics differ from the one or more first call characteristics.

In block 2008, the processor may perform operations including determining, within the total wait time, whether no active voice frames will be transmitted across an uplink to the third base station, or no active voice frames will be provided to audio decoding of the wireless device received across a downlink.

In block 2010, the processor may perform operations including resynchronizing the VoIP communications in response to determining that the one or more third call characteristics differ from the one or more first call characteristics and in response to determining that no active voice frames will be transmitted across the uplink or no active voice frames will be provided to audio decoding received across the downlink during the total wait time.

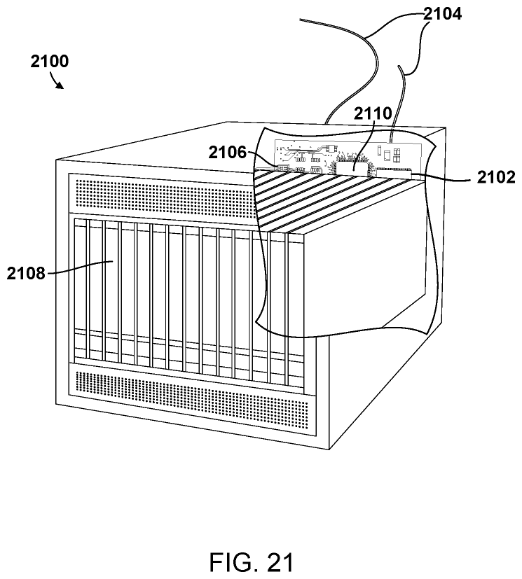

FIG. 21 is a component block diagram of an example of a network computing device 2100 that may determine when to resynchronize VoIP communications according to some embodiments. With reference to FIGS. 1-21, a network computing device 2100 may function as a network element of a communication network, such as a base station. The network computing device 2100 may include a processor 2110 (e.g., processor 210, 212, 214, 216, 218, 252, 260, 422) coupled to volatile memory 2102 and a large capacity nonvolatile memory 2108 (e.g., electronic storage 420). The network computing device 2100 also may include a peripheral memory access device such as a floppy disc drive, compact disc (CD) or digital video disc (DVD) drive 2106 coupled to the processor 2110. The network computing device 2100 also may include network access ports 2104 (or interfaces) coupled to the processor 2110 for establishing data connections with a network, such as the Internet or a local area network coupled to other system computers and servers. The network computing device 2100 may include one or more antennas 2104 for sending and receiving electromagnetic radiation that may be connected to a wireless communication link. The network computing device 2100 may include additional access ports, such as USB, Firewire, Thunderbolt, and the like for coupling to peripherals, external memory, or other devices.

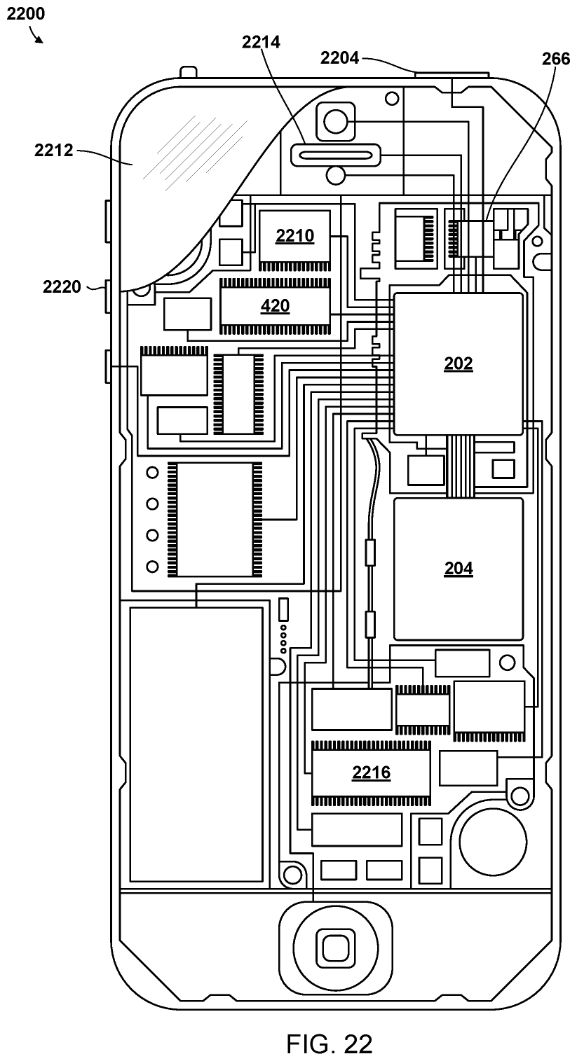

FIG. 22 is a component block diagram of an example wireless device in the form of a smartphone 2200 suitable for implementing some embodiments. With reference to FIGS. 1-22, a smartphone 2200 may include a first SOC 202 (such as a SOC-CPU) coupled to a second SOC 204 (such as a 5G capable SOC). The first and second SOCs 202, 204 may be coupled to internal memory 2216 (e.g., electronic storage 420), a display 2212, and to a speaker 2214. Additionally, the smartphone 2200 may include an antenna 2204 for sending and receiving electromagnetic radiation that may be connected to a wireless data link or cellular telephone transceiver 266 coupled to one or more processors in the first or second SOCs 202, 204. Smartphones 2200 typically also include menu selection buttons or rocker switches 2220 for receiving user inputs.

A typical smartphone 2200 also includes a sound encoding/decoding (CODEC) circuit 2210, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 266 and CODEC 2210 may include a digital signal processor (DSP) circuit (not shown separately).

The processors of the wireless network computing device 1800 and the smart phone 2200 may be any programmable microprocessor, microcomputer or multiple processor chip or chips that may be configured by processor-executable instructions to perform a variety of functions, including the functions of the various embodiments described herein. In some wireless devices, multiple processors may be provided, such as one processor within an SOC 204 dedicated to wireless communication functions and one processor within an SOC 202 dedicated to running other applications. Typically, software applications may be stored in the memory 420, 2216 before they are accessed and loaded into the processor. The processors may include internal memory sufficient to store the application software instructions.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various embodiments. Such services and standards include, such as third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (such as cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, or content messages. It should be understood that any references to terminology or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods disclosed herein may be substituted for or combined with one or more operations of the methods disclosed herein.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of various embodiments.

The hardware and data processing apparatus used to implement the various illustrative logics, logical blocks, modules, and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof Embodiments of the subject matter described in this specification also may be implemented as one or more computer programs, i.e. one or more modules of computer program instructions, encoded on a computer storage media for execution by, or to control the operation of, data processing apparatus.

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc in which disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the embodiments described in this disclosure may be readily apparent to those skilled in the art, and the generic principles defined herein may be applied to other embodiments without departing from the scope of the claims. Thus, the claims are not intended to be limited to the embodiments shown herein, but are to be accorded the widest scope consistent with this disclosure, the principles and the novel features disclosed herein.

What is claimed is:

1. A method performed by a processor of a wireless device for determining when to resynchronize voice-over IP (VoIP) communications of the wireless device, comprising:
storing one or more first call characteristics of VoIP communications between the wireless device and a first base station;
detecting whether the VoIP communications are transferred from the first base station to a second base station;
analyzing one or more second call characteristics of the VoIP communications between the wireless device and the second base station in response to detecting the VoIP communications are transferred from the first base station to the second base station;
determining whether the one or more second call characteristics differ from the one or more first call characteristics;
determining, within a total wait time, whether no active voice frames will be transmitted across an uplink to the second base station, or no active voice frames will be provided to audio decoding of the wireless device received across a downlink; and
resynchronizing the VoIP communications in response to determining that the one or more second call characteristics differ from the one or more first call characteristics and in response to determining that no active voice frames will be transmitted across the uplink or no active voice frames will be provided to audio decoding received across the downlink during the total wait time.

2. The method of claim 1, wherein resynchronizing the VoIP communications comprises:
resynchronizing an encoding timeline of the VoIP communications in response to determining, within the total wait time, that no active voice frames will be transmitted across the uplink to the second base station.

3. The method of claim 1, wherein resynchronizing the VoIP communications comprises:
resynchronizing a decoding timeline of the VoIP communications in response to determining, within the total wait time, that no active voice frames will be provided to the audio decoding of the wireless device received across the downlink.

4. The method of claim 1, further comprising:
determining whether the one or more first call characteristics are updated to become one or more updated call characteristics;
determining whether the one or more updated call characteristics differ from the one or more first call characteristics in response to determining that the one or more first call characteristics are updated to become the one or more updated call characteristics;
determining, within the total wait time, whether no active voice frames will be transmitted across an uplink, or no active voice frames will be provided to audio decoding of the wireless device received across a downlink; and
resynchronizing the VoIP communications in response to determining that the one or more updated call characteristics differ from the one or more first call characteristics and in response to determining that no active voice frames will be transmitted across the uplink or no active voice frames will be provided to audio decoding received across the downlink during the total wait time.

5. The method of claim 1, further comprising:
determining whether the VoIP communications are transferred from the second base station to a third base station before the VoIP communications are resynchronized to the second base station;
analyzing one or more third call characteristics of the VoIP communications between the wireless device and the third base station in response to determining that the VoIP communications are transferred from the second base station to the third base station;
determining whether the one or more third call characteristics differ from the one or more first call characteristics;
determining, within the total wait time, whether no active voice frames will be transmitted across an uplink to the third base station, or no active voice frames will be provided to audio decoding of the wireless device received across a downlink; and
resynchronizing the VoIP communications in response to determining that the one or more third call characteristics differ from the one or more first call characteristics and in response to determining that no active voice frames will be transmitted across the uplink or no active voice frames will be provided to audio decoding received across the downlink during the total wait time.

6. The method of claim 1, wherein analyzing the one or more second call characteristics of the VoIP communications between the wireless device and the second base station comprises:
analyzing a scheduling request (SR) configuration, including an SR periodicity and an SR offset, of the second base station;
analyzing a connected mode discontinuous reception (CDRX) configuration, including one or more of CDRX cycle length, CDRX start time (offset), onDurationTimer value, downlink (DL) hybrid Automatic Repeat Request round trip time (HARQ-RTT) timer value, or a DL retransmission timer value, of the second base station;
determining an encoding reference time of the VoIP communications between the wireless device and the second base station based on the SR configuration and the CDRX configuration;
determining a decoding reference time of the VoIP communications between the wireless device and the second base station based on the CDRX configuration; and
determining an audio exchange interval of the VoIP communications between the wireless device and the second base station based on the CDRX configuration.

7. The method of claim 1, wherein determining whether the one or more second call characteristics differ from the one or more first call characteristics comprises determining one or more of whether:
an encoding reference time of the VoIP communications between the wireless device and the first base station differs from an encoding reference time of the VoIP communications between the wireless device and the second base station;
a decoding reference time of the VoIP communications between the wireless device and the first base station differs from a decoding reference time of the VoIP communications between the wireless device and the second base station; or
an audio exchange interval of the VoIP communications between the wireless device and the first base station differs from an audio exchange interval of the VoIP communications between the wireless device and the second base station.

8. The method of claim 1, further comprising:
setting a resync timer to a minimum wait time in response to determining that the one or more second call characteristics differ from the one or more first call characteristics; and
starting the resync timer, wherein resynchronizing the VoIP communications occurs before expiration of the resync timer and a hard resync timer, and wherein the total wait time is a duration from a start time of the resync timer to the expiration of both the resync timer and the hard resync timer.

9. The method of claim 8, further comprising:
determining whether the resync timer and the hard resync timer have expired; and
resynchronizing the VoIP communications in response to expiration of the resync timer and the hard resync timer.

10. The method of claim 1, wherein the VoIP communications are connected mode discontinuous reception (CDRX) enabled.

11. A wireless device comprising:
a processor configured with processor-executable instructions to:
store one or more first call characteristics of VoIP communications between the wireless device and a first base station;
detect whether the VoIP communications are transferred from the first base station to a second base station;
analyze one or more second call characteristics of the VoIP communications between the wireless device and the second base station in response to detecting the VoIP communications are transferred from the first base station to the second base station;
determine whether the one or more second call characteristics differ from the one or more first call characteristics;
determine, within a total wait time, whether no active voice frames will be transmitted across an uplink to the second base station, or no active voice frames will be provided to audio decoding of the wireless device received across a downlink; and
resynchronize the VoIP communications in response to determining that the one or more second call characteristics differ from the one or more first call characteristics and in response to determining that no active voice frames will be transmitted across the uplink or no active voice frames will be provided to audio decoding received across the downlink during the total wait time.

12. The wireless device of claim 11, wherein the processor is further configured with processor-executable instructions to resynchronize the VoIP communications by:
resynchronizing an encoding timeline of the VoIP communications in response to deter mining, within the total wait time, that no active voice frames will be transmitted across the uplink to the second base station.

13. The wireless device of claim 11, wherein the processor is further configured with processor-executable instructions to resynchronize the VoIP communications by:
resynchronizing a decoding timeline of the VoIP communications in response to determining, within the total wait time, that no active voice frames will be provided to the audio decoding of the wireless device received across the downlink.

14. The wireless device of claim 11, wherein the processor is further configured with processor-executable instructions to:
determine whether the one or more first call characteristics are updated to become one or more updated call characteristics;
determine whether the one or more updated call characteristics differ from the one or more first call characteristics in response to determining that the one or more first call characteristics are updated to become the one or more updated call characteristics;
determine, within the total wait time, whether no active voice frames will be transmitted across an uplink, or no active voice frames will be provided to audio decoding of the wireless device received across a downlink; and
resynchronize the VoIP communications in response to determining that the one or more updated call characteristics differ from the one or more first call characteristics and in response to determining that no active voice frames will be transmitted across the uplink or no active voice frames will be provided to audio decoding received across the downlink during the total wait time.

15. The wireless device of claim 11, wherein the processor is further configured with processor-executable instructions to:
determine whether the VoIP communications are transferred from the second base station to a third base station before the VoIP communications are resynchronized to the second base station;
analyze one or more third call characteristics of the VoIP communications between the wireless device and the third base station in response to determining that the VoIP communications are transferred from the second base station to the third base station;
determine whether the one or more third call characteristics differ from the one or more first call characteristics;
determine, within the total wait time, whether no active voice frames will be transmitted across an uplink to the third base station, or no active voice frames will be provided to audio decoding of the wireless device received across a downlink; and
resynchronize the VoIP communications in response to determining that the one or more third call characteristics differ from the one or more first call characteristics and in response to determining that no active voice frames will be transmitted across the uplink or no active voice frames will be provided to audio decoding received across the downlink during the total wait time.

16. The wireless device of claim 11, wherein the processor is further configured with processor-executable instructions to analyze the one or more second call characteristics of the VoIP communications between the wireless device and the second base station by:
analyzing a scheduling request (SR) configuration, including an SR periodicity and an SR offset, of the second base station;
analyzing a connected mode discontinuous reception (CDRX) configuration, including one or more of CDRX cycle length, CDRX start time (offset), onDurationTimer value, downlink (DL) hybrid Automatic Repeat Request round trip time (HARQ-RTT) timer value, or a DL retransmission timer value, of the second base station;
determining an encoding reference time of the VoIP communications between the wireless device and the second base station based on the SR configuration and the CDRX configuration;
determining a decoding reference time of the VoIP communications between the wireless device and the second base station based on the CDRX configuration; and
determining an audio exchange interval of the VoIP communications between the wireless device and the second base station based on the CDRX configuration.

17. The wireless device of claim 11, wherein the processor is further configured with processor-executable instructions to determine whether the one or more second call characteristics differ from the one or more first call characteristics by determining one or more of whether:
an encoding reference time of the VoIP communications between the wireless device and the first base station differs from an encoding reference time of the VoIP communications between the wireless device and the second base station;
a decoding reference time of the VoIP communications between the wireless device and the first base station differs from a decoding reference time of the VoIP communications between the wireless device and the second base station; or
an audio exchange interval of the VoIP communications between the wireless device and the first base station differs from an audio exchange interval of the VoIP communications between the wireless device and the second base station.

18. The wireless device of claim 11, wherein the processor is further configured with processor-executable instructions to:
set a resync timer to a minimum wait time in response to determining that the one or more second call characteristics differ from the one or more first call characteristics; and
start the resync timer, wherein resynchronizing the VoIP communications occurs before expiration of the resync timer and a hard resync timer, and wherein the total wait time is a duration from a start time of the resync timer to the expiration of both the resync timer and the hard resync timer.

19. The wireless device of claim 18, wherein the processor is further configured with processor-executable instructions to:
determine whether the resync timer and the hard resync timer have expired; and
resynchronize the VoIP communications in response to expiration of the resync timer and the hard resync timer.

20. The wireless device of claim 11, wherein the VoIP communications are connected mode discontinuous reception (CDRX) enabled.

21. A wireless device, comprising:
means for storing one or more first call characteristics of VoIP communications between the wireless device and a first base station;
means for detecting whether the VoIP communications are transferred from the first base station to a second base station;
means for analyzing one or more second call characteristics of the VoIP communications between the wireless device and the second base station in response to detecting the VoIP communications are transferred from the first base station to the second base station;
means for determining whether the one or more second call characteristics differ from the one or more first call characteristics;
means for determining, within a total wait time, whether no active voice frames will be transmitted across an uplink to the second base station, or no active voice frames will be provided to audio decoding of the wireless device received across a downlink; and
means for resynchronizing the VoIP communications in response to determining that the one or more second call characteristics differ from the one or more first call characteristics and in response to determining that no active voice frames will be transmitted across the uplink or no active voice frames will be provided to audio decoding received across the downlink during the total wait time.

22. A non-transitory processor-readable medium having stored thereon processor-executable instructions configured to cause a processor of wireless device to perform operations comprising:
storing one or more first call characteristics of VoIP communications between the wireless device and a first base station;
detecting whether the VoIP communications are transferred from the first base station to a second base station;
analyzing one or more second call characteristics of the VoIP communications between the wireless device and the second base station in response to detecting the VoIP communications are transferred from the first base station to the second base station;
determining whether the one or more second call characteristics differ from the one or more first call characteristics;
determining, within a total wait time, whether no active voice frames will be transmitted across an uplink to the second base station, or no active voice frames will be provided to audio decoding of the wireless device received across a downlink; and
resynchronizing the VoIP communications in response to determining that the one or more second call characteristics differ from the one or more first call characteristics and in response to determining that no active voice frames will be transmitted across the uplink or no active voice frames will be provided to audio decoding received across the downlink during the total wait time.

23. The non-transitory processor-readable medium of claim 22, wherein the stored processor-executable instructions are configured to cause a processor of wireless device to perform operations such that resynchronizing the VoIP communications comprises:
resynchronizing an encoding timeline of the VoIP communications in response to deter mining, within the total wait time, that no active voice frames will be transmitted across the uplink to the second base station.

24. The non-transitory processor-readable medium of claim 22, wherein the stored processor-executable instructions are configured to cause a processor of wireless device to perform operations such that resynchronizing the VoIP communications comprises:
resynchronizing a decoding timeline of the VoIP communications in response to determining, within the total wait time, that no active voice frames will be provided to the audio decoding of the wireless device received across the downlink.

25. The non-transitory processor-readable medium of claim 22, wherein the stored processor-executable instructions are configured to cause a processor of wireless device to perform operations further comprising:
determining whether the one or more first call characteristics are updated to become one or more updated call characteristics;
determining whether the one or more updated call characteristics differ from the one or more first call characteristics in response to determining that the one or more first call characteristics are updated to become the one or more updated call characteristics;
determining, within the total wait time, whether no active voice frames will be transmitted across an uplink, or no active voice frames will be provided to audio decoding of the wireless device received across a downlink; and
resynchronizing the VoIP communications in response to determining that the one or more updated call characteristics differ from the one or more first call characteristics and in response to determining that no active voice frames will be transmitted across the uplink or no active voice frames will be provided to audio decoding received across the downlink during the total wait time.

26. The non-transitory processor-readable medium of claim 22, wherein the stored processor-executable instructions are configured to cause a processor of wireless device to perform operations further comprising:
determining whether the VoIP communications are transferred from the second base station to a third base station before the VoIP communications are resynchronized to the second base station;
analyzing one or more third call characteristics of the VoIP communications between the wireless device and the third base station in response to determining that the VoIP communications are transferred from the second base station to the third base station;
determining whether the one or more third call characteristics differ from the one or more first call characteristics;
determining, within the total wait time, whether no active voice frames will be transmitted across an uplink to the third base station, or no active voice frames will be provided to audio decoding of the wireless device received across a downlink; and
resynchronizing the VoIP communications in response to determining that the one or more third call characteristics differ from the one or more first call characteristics and in response to determining that no active voice frames will be transmitted across the uplink or no active voice frames will be provided to audio decoding received across the downlink during the total wait time.

27. The non-transitory processor-readable medium of claim 22, wherein the stored processor-executable instructions are configured to cause a processor of wireless device to perform operations such that analyzing the one or more second call characteristics of the VoIP communications between the wireless device and the second base station comprises:
analyzing a scheduling request (SR) configuration, including an SR periodicity and an SR offset, of the second base station;
analyzing a connected mode discontinuous reception (CDRX) configuration, including one or more of CDRX cycle length, CDRX start time (offset), onDurationTimer value, downlink (DL) hybrid Automatic Repeat Request round trip time (HARQ-RTT) timer value, or a DL retransmission timer value, of the second base station;
determining an encoding reference time of the VoIP communications between the wireless device and the second base station based on the SR configuration and the CDRX configuration;
determining a decoding reference time of the VoIP communications between the wireless device and the second base station based on the CDRX configuration; and
determining an audio exchange interval of the VoIP communications between the wireless device and the second base station based on the CDRX configuration.

28. The non-transitory processor-readable medium of claim 22, wherein the stored processor-executable instructions are configured to cause a processor of wireless device to perform operations such that determining whether the one or more second call characteristics differ from the one or more first call characteristics comprises determining one or more of whether:
an encoding reference time of the VoIP communications between the wireless device and the first base station differs from an encoding reference time of the VoIP communications between the wireless device and the second base station;
a decoding reference time of the VoIP communications between the wireless device and the first base station differs from a decoding reference time of the VoIP communications between the wireless device and the second base station; or
an audio exchange interval of the VoIP communications between the wireless device and the first base station differs from an audio exchange interval of the VoIP communications between the wireless device and the second base station.

29. The non-transitory processor-readable medium of claim 22, wherein the stored processor-executable instructions are configured to cause a processor of wireless device to perform operations further comprising:
setting a resync timer to a minimum wait time in response to determining that the one or more second call characteristics differ from the one or more first call characteristics; and
starting the resync timer, wherein resynchronizing the VoIP communications occurs before expiration of the resync timer and a hard resync timer, and wherein the total wait time is a duration from a start time of the resync timer to the expiration of both the resync timer and the hard resync timer.

30. The non-transitory processor-readable medium of claim 29, wherein the stored processor-executable instructions are configured to cause a processor of wireless device to perform operations further comprising:
determining whether the resync timer and the hard resync timer have expired; and
resynchronizing the VoIP communications in response to expiration of the resync timer and the hard resync timer.
